(19) United States
(12) Patent Application Publication
(10) Pub. No.: US 2024/0205585 A1
(43) Pub. Date: Jun. 20, 2024

(54) APPARATUSES AND METHODS FOR PROVIDING RESPIRATORY PROTECTIVE DEVICES WITH DETACHABLE AND OVERRIDABLE EARPIECES

(71) Applicant: HONEYWELL INTERNATIONAL INC., Charlotte, NC (US)

(72) Inventors: En Yi CHEN, Charlotte, NC (US); Hang TIAN, Charlotte, NC (US); Li CHENG, Charlotte, NC (US)

(21) Appl. No.: 18/521,706

(22) Filed: Nov. 28, 2023

(30) Foreign Application Priority Data
Dec. 19, 2022 (CN) 202211631906.4

(51) Int. Cl. H04R 1/10; A62B 18/08; H04R 1/02

(52) U.S. Cl. CPC H04R 1/1041; A62B 18/08; H04R 1/028; H04R 1/1016; H04R 1/1025; H04R 1/1083; H04R 2460/01

(57) ABSTRACT

Example apparatuses, systems, and methods for providing respiratory protective devices with detachable and overridable earpieces are provided. For example, an example respiratory protective device includes an earpiece connector component detachably connected to the respiratory protective device and a main controller component electronically coupled to the earpiece connector component.

### CROSS-REFERENCE TO RELATED APPLICATIONS

This application claims priority pursuant to 35 U.S.C. 119(a) to Chinese Application No. 202211631906.4, filed Dec. 19, 2022, which application is incorporated herein by reference in its entirety.

### FIELD OF THE INVENTION

Example embodiments of the present disclosure relate generally to respiratory protective devices and, more particularly, to apparatuses and methods for providing detachable and overridable earpieces that can be used in connection with respiratory protective devices and/or separate from the respiratory protective devices.

### BACKGROUND

Applicant has identified many technical challenges and difficulties associated with masks. For example, many users may need to wear earphones while wearing masks. However, many masks do not have the capability to provide any connection to earphones.

### BRIEF SUMMARY

Various embodiments described herein relate to methods, apparatuses, and systems for providing detachable and overridable earpieces in respiratory protective devices are provided.

In accordance with some embodiments of the present disclosure, an example respiratory protective device is provided. In some embodiments, the example respiratory protective device comprises an earpiece connector component detachably connected to the respiratory protective device; and a main controller component electronically coupled to the earpiece connector component. In some embodiments, the main controller component is configured to: in response to receiving an earpiece connection signal associated with an earpiece device from the earpiece connector component: transmit a primary sound sensor activation signal to a device sound sensor component disposed on the respiratory protective device; and transmit at least one of a reference sound sensor activation signal or a sound sensor deactivation signal to an earpiece sound sensor component of the earpiece device.

In some embodiments, the earpiece connector component comprises a connector plug that is detachably connected to a connector receptacle disposed on an outer surface of the respiratory protective device.

In some embodiments, the respiratory protective device comprises a device power source component and a device data communication component, wherein the earpiece connector component comprises: at least one power cable electronically coupled to the device power source component; at least one data cable electronically coupled to the device data communication component; and an earpiece receptacle comprising at least one power charging pin and at least one data transfer pin, wherein the at least one power charging pin is electronically coupled to the at least one power cable, wherein the at least one data transfer pin is electronically coupled to the at least one data cable.

In some embodiments, the earpiece device comprises at least one power connector contact and at least one data connector contact. In some embodiments, when the at least one power charging pin is electronically coupled to the at least one power connector contact, the earpiece connector component is configured to generate the earpiece connection signal.

In some embodiments, in response to receiving the earpiece connection signal from the earpiece connector component, the main controller component is configured to: determine whether a noise reduction indication is received by the main controller component.

In some embodiments, the main controller component is configured to: in response to determining that the noise reduction indication is received by the main controller component, transmit the reference sound sensor activation signal to the earpiece sound sensor component of the earpiece device.

In some embodiments, the main controller component is configured to: in response to determining that the noise reduction indication is not received by the main controller component, transmit the sound sensor deactivation signal to the earpiece sound sensor component of the earpiece device.

In some embodiments, the earpiece device comprises an earpiece power source component. In some embodiments, the respiratory protective device comprises a device power source component, wherein the main controller component is configured to: in response to receiving the earpiece connection signal from the earpiece connector component, transmit a power charging signal to the device power source component to cause the device power source component to charge the earpiece power source component of the earpiece device.

In some embodiments, the earpiece device comprises an earpiece data communication component. In some embodiments, the respiratory protective device comprises a device data communication component. In some embodiments, the main controller component is configured to: in response to receiving the earpiece connection signal from the earpiece connector component: transmit a data communication activation signal to the device data communication component; and transmit a data communication deactivation signal to the earpiece data communication component.

In some embodiments, the earpiece device comprises an earpiece data communication component. In some embodiments, the respiratory protective device comprises a device data communication component. In some embodiments, the main controller component is configured to: in response to receiving the earpiece connection signal from the earpiece connector component: transmit a data communication deactivation signal to the device data communication component; and transmit a data communication activation signal to the earpiece data communication component.

In accordance with various embodiments of the present disclosure, a computer-implemented method is provided. In some embodiments, the computer-implemented method comprises: receiving, by a main controller component of a respiratory protective device, an earpiece connection signal associated with an earpiece device from an earpiece connector component; and in response to receiving the earpiece connection signal: transmitting, by the main controller component, a primary sound sensor activation signal to a device sound sensor component disposed on the respiratory protective device; and transmitting, by the main controller component, at least one of a reference sound sensor activation signal or a sound sensor deactivation signal to an earpiece sound sensor component of the earpiece device.

In accordance with various embodiments of the present disclosure, a computer program product is provided. In some embodiments, the computer program product comprises at least one non-transitory computer-readable storage medium having computer-readable program code portions stored therein, and the computer-readable program code portions comprise an executable portion configured to: receive, by a main controller component of a respiratory protective device, an earpiece connection signal associated with an earpiece device from an earpiece connector component; and in response to receiving the earpiece connection signal: transmit, by the main controller component, a primary sound sensor activation signal to a device sound sensor component disposed on the respiratory protective device; and transmit, by the main controller component, at least one of a reference sound sensor activation signal or a sound sensor deactivation signal to an earpiece sound sensor component of the earpiece device.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates an example side view of an example respiratory protective device in accordance with some example embodiments described herein;

FIG. 2A illustrates an example exploded view of an example mask component in accordance with some example embodiments described herein;

FIG. 2B illustrates another example exploded view of an example mask component in accordance with some example embodiments described herein;

FIG. 2C illustrates another example exploded view of an example mask component in accordance with some example embodiments described herein;

FIG. 2D illustrates an example back view of an example mask component in accordance with some example embodiments described herein;

FIG. 3 provides an example block diagram illustrating example components associated with an example respiratory protective device in accordance with some embodiments of the present disclosure;

FIG. 4 provides an example circuit diagram illustrating example data communications between example components of an example respiratory protective device in accordance with some example embodiments described herein;

FIG. 5A illustrates an example earpiece connector component of an example respiratory protective device in accordance with some embodiments of the present disclosure;

FIG. 5B illustrates an example portion of the example earpiece connector component shown in FIG. 5A in accordance with some embodiments of the present disclosure;

FIG. 6 illustrates an example view of an example earpiece device in accordance with some embodiments of the present disclosure;

FIG. 7 provides an example circuit diagram illustrating example data communications between example components of an example earpiece device in accordance with some example embodiments described herein;

FIG. 8 provides an example illustration of an example user wearing an example respiratory protective device and an example earpiece device in accordance with some embodiments of the present disclosure;

FIG. 9 provides an example illustrations of an example user wearing an example respiratory protective device without wearing any example earpiece devices in accordance with some embodiments of the present disclosure;

FIG. 10 provides an example flow diagram illustrating an example method in accordance with some embodiments of the present disclosure;

FIG. 11 provides an example flow diagram illustrating an example method in accordance with some embodiments of the present disclosure;

FIG. 12 provides an example flow diagram illustrating an example method in accordance with some embodiments of the present disclosure;

FIG. 13 provides an example flow diagram illustrating an example method in accordance with some embodiments of the present disclosure;

FIG. 14 provides an example illustrations of an example user wearing an example earpiece device without wearing any example respiratory protective devices in accordance with some embodiments of the present disclosure; and

FIG. 15 provides an example flow diagram illustrating an example method in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The term “electronically coupled,” “electronically coupling,” “electronically couple,” “in communication with,” “in electronic communication with,” “in electronic communications with,” or “connected” in the present disclosure refers to two or more elements or components being connected through wired means (such as, but not limited to, through direct coupling or conductive coupling) and/or connected through wireless means (such as, but not limited to, through electromagnetic induction or capacitive coupling), such that electrical energy (such as, but not limited to, electrical voltage, electrical current, and/or the like) can be transferring between and among the two or more elements or components.

Respiratory protective devices (such as, but not limited to, masks, respirators, and/or the like) can protect the health of not only those who wear them, but also those around people who wear them. For example, when a user wears a respiratory protective device, the respiratory protective device can prevent inhalation of hazardous substances (such as, but not limited to, harmful dusts, smokes, mists, gasses, vapors, and/or the like) from the environment. As another example, respiratory protective devices can reduce the likelihood and the amount of droplets and aerosols that are released by users who wear them into the environment through exhalation, therefore can reduce and/or prevent spreading of respiratory viruses.

However, there are many technical challenges and difficulties associated with respiratory protective devices.

For example, many users need to wear headphones, headsets, earphones, earbuds, and/or the like while wearing respiratory protective devices. As an example, a worker at a work site may be required to wear respiratory protective devices such as, but not limited to, masks, respirators, and/or the like to prevent inhalation of hazardous substances from the environment and, at the same time, may be required to wear earbuds to listen to and communicate with fellow workers.

As another example, users may wear earbuds for sports and/or outdoor activities. When the air quality is poor, users also need to wear masks. Many masks can be boring to wear. A mask with active ventilation can make breathing easier. A mask with both earbud music function and active air supply function can better satisfy users' needs.

Some masks may provide earbuds that are secured to the masks via a cable. However, the fixed connection between the earbuds and the masks can cause many technical challenges and difficulties. Continuing from the example above, after the worker leaves the work site and enters a safe environment, the worker may no longer need to wear the respiratory protective devices, but may still need to wear earbuds to listen to and communicate with fellow workers. Because of the fixed connection between the earbuds and the masks, the user cannot detach earbuds from the masks and may continue wearing the masks, causing unnecessary occupancy of personal protective equipment (PPE) resources that are often limited in work sites.

Some masks may allow users to wear earbuds that are separated from the masks. Because at least mouth regions of users who wear masks are covered, the quality of voice and sound captured by microphones in the earbuds is suboptimal at best. In other words, masks can often block progressions of sound waves from users' mouths to microphones in the earbuds, resulting in mumbled voices being captured by the microphones in the earbuds.

Various embodiments of the present disclosure overcome these technical challenges and difficulties, and provide various technical improvements and benefits. For example, an example earpiece device in accordance with some embodiments of the present disclosure is detachable and overridable from an example respiratory protective device.

In some embodiments, the example earpiece device is detachable from the example respiratory protective device as it is not fixedly fastened to the example respiratory protective device. For example, the respiratory protective device may comprise an earpiece connector component that includes an earpiece receptacle. In some embodiments, the example earpiece device can be secured to the respiratory protective device through the earpiece receptacle of the earpiece connector component. In some embodiments, the example earpiece device can be detached from the respiratory protective device by removing the example earpiece device from the earpiece receptacle of the earpiece connector component. In some embodiments, the example earpiece device provides true wireless stereo (TWS) earbud features such as, but not limited to, playing music, active noise cancellation (ANC), key presses, and/or the like. As such, the example respiratory protective device in accordance with some embodiments of the present disclosure overcomes technical challenges and difficulties associated with the fixed connection between the earbuds and the masks described above.

In some embodiments, the example earpiece device is overridable from the example respiratory protective device. For example, the example earpiece device provides functionalities in addition to TWS earbud features such as, but not limited to, receiving data associated with the respiratory protective device, transmitting data associated with the respiratory protective device, transmitting command signals to control the fan component(s) of the respiratory protective device (such as, but not limited to, controlling the fan speed(s) of the fan component(s)), transmitting command signals to control one or more light components (such as, but not limited to, LED rings).

As such, various embodiments of the present disclosure provide an example respiratory protective device and an earpiece device that can be used separately from each other or in combination with one another.

For example, in some embodiments, when the example earpiece device is used separately from the example respiratory protective device, the example earpiece device can wirelessly communicate data with the example respiratory protective device. In some embodiments, the example earpiece device is also in data communication with a mobile device such as, but not limited to, a mobile smart phone. As an example, one or more applications (or “apps”) may be installed on the mobile smart phone, and the example earpiece device can transfer data associated with the example respiratory protective device to the app on the mobile smart phone. In some embodiments, when the data transfer is completed, the data communication channel(s) between the example earpiece device and the example respiratory protective device are disconnected so that the power in the example respiratory protective device and the power in the example earpiece device can be preserved.

In some embodiments, when the example earpiece device is used in connection with the example respiratory protective device, the data communications between the example earpiece device and the example respiratory protective device enable better sound pickup qualities. As described above, it can be technically challenging and difficult for voice waves to pass outside the example respiratory protective device due to the sound insulation effects of the example respiratory protective device. In some embodiments, the example respiratory protective device comprises a device sound sensor component (such as, but not limited to, a microphone) that is disposed on the inner surface of the example respiratory protective device. In such examples, the device sound sensor component of the example respiratory protective device can be activated as the primary sound sensor. For example, when a user is conducting a telephone call wearing the example earpiece device and the example respiratory protective device, the speaker of the example earpiece device can output sounds, while the microphone of the example respiratory protective device can provide input of the user's voice to the telephone call.

In some embodiments, when the example earpiece device is used in connection with the example respiratory protective device, they can provide features such as, but not limited to, active noise cancellation (ANC) as there is a microphone in the example respiratory protective device and a microphone in the example earpiece device.

In some embodiments, when the example earpiece device is used in connection with the example respiratory protective device, the example respiratory protective device can charge the example earpiece device.

As such, the above technical advantages associated with an example respiratory protective device and an earpiece device being able to be used separately from each other or in combination with one another can provide various technical benefits, such as, but not limited to, in various example use cases.

For example, an example respiratory protective device in accordance with some embodiments of the present disclosure can be used in connection with multiple, different earpiece devices. In particular, the earpiece receptacle of the example earpiece connector component described above provides a universal interface for different earpiece devices. For example, some earpiece devices may provide greater features and focus on bass performance, while some other earpiece devices may provide greater features and focus on treble performance. As such, the universal interface of the earpiece receptacle of the example earpiece connector component enables different customers to choose earpiece devices according to their favorite features.

Additionally, or alternatively, different earpiece devices may be associated with different colors. For example, users may associate different colors of the earpiece devices with different moods, and users can replace their favorite color for the earpiece devices at any time. While the description above provides an example of connection between the example respiratory protective device and the example respiratory protective device through an example cable connection, it is noted that the scope of the present disclosure is not limited to the description above. In some examples, an example earpiece device may communicate with an example respiratory protective device wirelessly and without any data cable. For example, when a user answers the phone from the earpiece device, the users can do so without having to connect the earpiece device through the earpiece device and without the need to wire the earpiece device to the respiratory protective device.

In some embodiments, the example earpiece device can be used as a single product without the respiratory protective device. For example, when a user is listening to music at home, the user may use the example earpiece device to listen to music.

In some embodiments, an example respiratory protective device in accordance with some embodiments of the present disclosure incorporates wearable technology so that it is ergonomically fit and enhanced with multiple functions for a modern lifestyle of a user. For example, the example respiratory protective device may comprise one or more High-Efficiency Particulate Air (HEPA) filters, one or more breath pattern detection mechanisms, one or more Near-Field Communication (NFC) components, one or more air quality monitoring mechanisms, and/or the like, such that the example respiratory protective device can provide optimal breathability for a user. In example embodiments, an example respiratory protective device provides Active Noise Canceling (ANC) audio and Environmental Noise Cancellation (ENC) microphone capabilities, Bluetooth® 5.2 connectivity, and a magnetic docking system for and more.

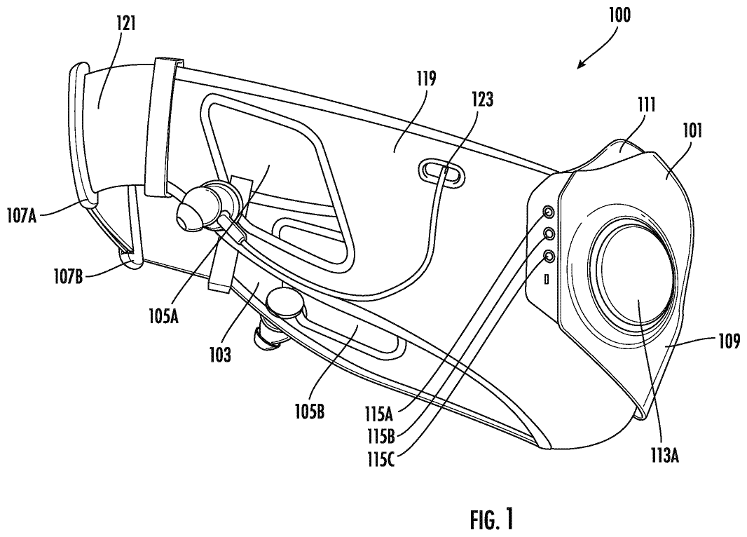

Referring now to FIG. 1, an example perspective view of an example respiratory protective device 100 (also referred to as a respiratory protective equipment) in accordance with some example embodiments described herein is illustrated.

In some embodiments, the example respiratory protective device 100 is in the form of a respirator or a mask. For example, as shown in FIG. 1, the example respiratory protective device 100 comprises a mask component 101 and a strap component 103.

While the description above provides an example of a respiratory protective device in the form of a respirator/mask, it is noted that the scope of the present disclosure is not limited to the description above. In some examples, an example respiratory protective device may be in one or more additional and/or alternative forms.

Referring back to FIG. 1, in some embodiments, the strap component 103 may be in the form of a strap that connects or fastens one end of the mask component 101 to another end of the mask component 101.

In some embodiments, the strap component 103 comprises at least one non-elastic portion 119 and at least one elastic portion 121. In some embodiments, the at least one clastic portion 121 is connected to the at least one non-elastic portion 119.

In some embodiments, the at least one non-elastic portion 119 may comprise nonelastic materials or materials with low elasticity such as, but not limited to, cotton, yarns, fabric (including, but not limited to, woven fabric, non-woven fabric), and/or the like. In some embodiments, the mask component 101 is secured on the at least one non-clastic portion 119.

In some embodiments, at least one elastic portion 121 may comprise elastic material(s) such as, but not limited to, polymers, thermoplastic elastomers (TPE), and/or the like. In some embodiments, the at least one elastic portion 121 allows the strap component 103 to adapt to different head sizes of users.

For example, in the example shown in FIG. 1, the at least one elastic portion 121 of the strap component 103 may be inserted through one or more strap bucket components (such as the strap bucket component 107A and the strap bucket component 107B as shown in FIG. 1). In some embodiments, the one or more strap bucket components (such as the strap bucket component 107A and the strap bucket component 107B as shown in FIG. 1) may be in the form of one or more buckles that include, but not limited to, a tri-glide buckle). In some embodiments, when the one or more strap bucket components (such as the strap bucket component 107A and the strap bucket component 107B as shown in FIG. 1) move along the at least one elastic portion 121 of the strap component 103, the length of the strap component 103 is adjusted. As such, a user can adjust the length of the strap component 103 so that the example respiratory protective device 100 can be secured to a user's face.

In some embodiments, the strap component 103 may comprise an car opening 105A and an car opening 105B. When the example respiratory protective device 100 is worn by a user, the car opening 105A and the car opening 105B may allow the user's left car and right car to pass through.

In some embodiments, the mask component 101 is connected or fastened to the strap component 103. In the example shown in FIG. 1, the mask component 101 is secured to the at least one non-elastic portion 119 of the strap component 103. For example, the mask component 101 may be fastened to the at least one non-elastic portion 119 of the strap component 103 through one or more chemical glues. Additionally, or alternatively, the mask component 101 may be fastened to the at least one non-elastic portion 119 of the strap component 103 through one or more fastener components (such as, but not limited to, one or more snap buttons).

While the description above provides an example fastening mechanism to secure the mask component to the strap component, it is noted that the scope of the present disclosure is not limited to the description above. In some examples, an example mask component may be secured to an example strap component through one or more additional and/or alternative mechanisms. For example, a first end of the strap component can be connected to a first end of the mask component, and a second end of the strap component can be connected to a second of the mask component. In this example, the first end of the mask component is opposite to the second end of the mask component.

As described above, the mask component 101 may be in the form of a mask or a respirator. In the example shown in FIG. 1, the mask component 101 may comprise an outer shell component 109 and a face seal component 111.

In some embodiments, when the example respiratory protective device 100 is worn by a user, an outer surface of the outer shell component 109 is exposed to the outside environment. In some embodiments, the face seal component 111 is attached to and extends from a periphery and/or edge of the outer shell component 109 (or is attached to and extends from a periphery and/or edge of or an inner shell component of the mask component as described herein).

In some embodiments, the face seal component 111 may comprise soft material such as, but not limited to, silica gel. In some embodiments, when the example respiratory protective device 100 is worn by a user, the face seal component 111 is in contact with the user's face, and may seal the example respiratory protective device 100 to at least a portion of a user's face. As described above, the example respiratory protective device 100 includes a strap component 103 that allows the example respiratory protective device 100 to be secured to the user's head. As such, the face seal component 111 can create at least partially enclosed (or entirely enclosed) space between at least a portion of the user's face (e.g. mouth, nostrils, etc.) and the example respiratory protective device 100, details of which are described herein.

In some embodiments, the mask component 101 comprises one or more puck components that cover one or more inhalation filtration components of the example respiratory protective device 100. In some embodiments, each of the puck components is in the form of a circular cover structure. Additionally, or alternatively, each of the puck components can be in other shapes and/or forms.

In the example shown in FIG. 1, the example respiratory protective device 100 comprises a first puck component 113A that is disposed on a left side of the outer shell component 109 and a second puck component that is disposed on a right side of the outer shell component 109. In such an example, the first puck component 113A covers a first inhalation filtration component that is disposed on the left side of the mask component 101, and the second puck component covers a second inhalation filtration component that is disposed on the right side of the mask component 101, details of which are described herein.

In some embodiments, the mask component 101 comprises one or more key components (such as, but not limited to, the key component 115A, the key component 115B, and the key component 115C as shown in FIG. 1). In some embodiments, each of the one or more key components is a physical button that may allow a user to manually control operations of various components of the mask component 101 (such as, but not limited to, the fan components as described herein) and/or other devices that are in electronic communication with the example respiratory protective device 100 (such as, but not limited to, earpiece devices).

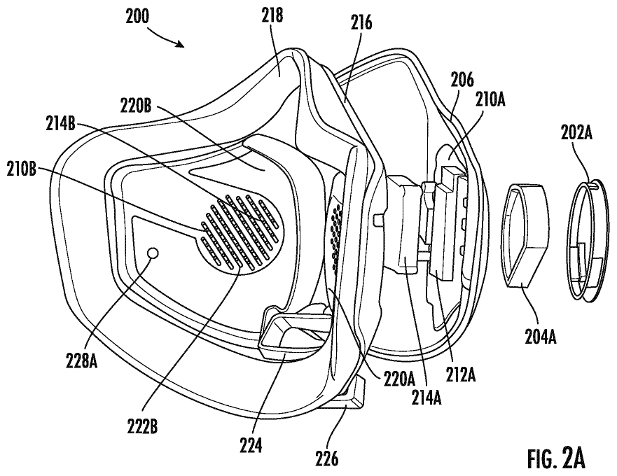

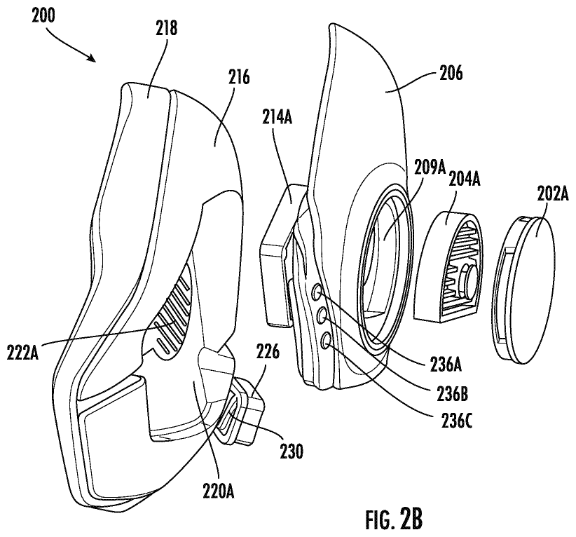

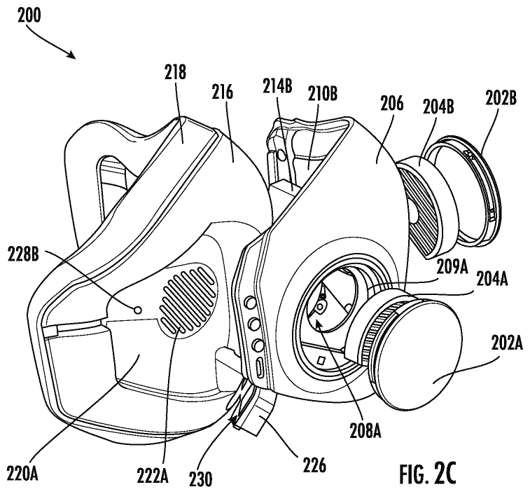

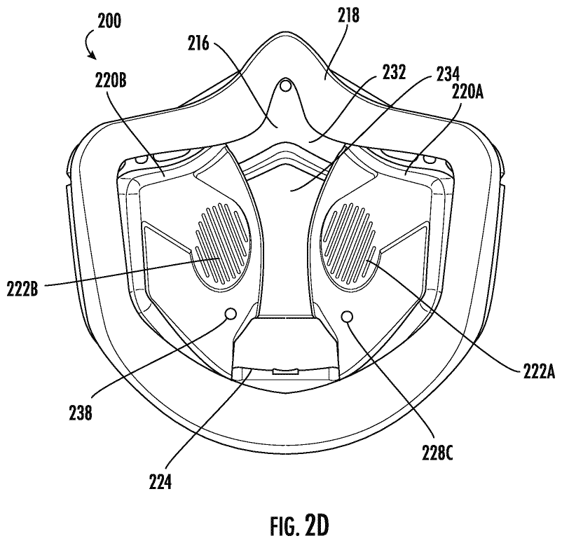

Referring now to FIG. 2A, FIG. 2B, FIG. 2C, and FIG. 2D, example views of an example mask component 200 in accordance with some example embodiments of the present disclosure are illustrated. In particular, FIG. 2A to FIG. 2C illustrate example exploded views of the example mask component 200, and FIG. 2D illustrates an example back view of the example mask component 200.

As shown in FIG. 2A, the mask component 200 comprises an outer shell component 206 and an inner shell component 216.

In some embodiments, the inner shell component 216 may be in a shape that is based on the contour of the user's face. In particular, when the mask component 200 is worn by a user, at least a portion of the user's face (such as, but not limited to, mouth, nostrils) are housed within the inner shell component 216.

In some embodiments, the mask component 200 may comprise a face seal component 218. In some embodiments, the face seal component 218 is attached to and extends from a periphery and/or edge of the inner shell component 216. Similar to the face seal component 111 described above in connection with FIG. 1, the face seal component 218 may comprise soft material such as, but not limited to, silica gel. In some embodiments, when the mask component 200 is worn by a user, the face seal component 218 and an inner surface of the inner shell component 216 create an enclosed space between at least a portion of the user's face (e.g. on the mouth, nostrils, etc.) and the mask component 200.

Similar to the shape of the inner shell component 216 described above, the shape of the outer shell component 206 may be based on a contour of the user's face. In some embodiments, when the mask component 200 is assembled, the inner surface of the outer shell component 206 is secured to an outer surface of the inner shell component 216.

In some embodiments, the inner shell component 216 may comprise one or more indentation portions on the outer surface of the inner shell component 216. In particular, each of the one or more indentation portions may be sunken or depressed from the outer surface of the inner shell component 216. In the example shown in FIG. 2A, FIG. 2B, and FIG. 2C, the inner shell component 216 may comprise inner shell indentation portions such as, but not limited to, an inner shell indentation portion 220A that is on a left side of the inner shell component 216 and an inner shell indentation portion 220B that is on a right side of the inner shell component 216.

In some embodiments, when the inner surface of the outer shell component 206 is secured to outer surface of the inner shell component 216, the indentation portions of the inner shell component 216 (e.g., the inner shell indentation portion 220A and inner shell indentation portion 220B) may create space between the inner shell component 216 and the outer shell component 206.

In some embodiments, one or more components of the mask component 200 are housed, disposed, or positioned within the space formed by the indentation portions of the inner shell component 216 (e.g., the inner shell indentation portion 220A and inner shell indentation portion 220B) and the outer shell component 206. For example, one or more circuit board components, one or more power charging components, and one or more fan components may be disposed in the space that is defined by the inner shell indentation portions of the inner shell component 216 and the outer shell component 206.

In the examples shown in FIG. 2A, FIG. 2B, and FIG. 2C, a circuit board component 210A, a power charging component 212A, and a fan component 214A are disposed in the space that is defined by the inner shell indentation portion 220A of the inner shell component 216 and the outer shell component 206. Additionally, or alternatively, a circuit board component 210B, a power charging component, and a fan component 214B are disposed in the space that is defined by the inner shell indentation portion 220B and the outer shell component 206.

In some embodiments, an example circuit board component comprises a medium or a substrate where one or more electronic components can be secured to and in electronic communications with one another. In some embodiments, an example circuit board component may be in the form of one or more printed circuit boards (PCBs). For example, the example circuit board component may comprise one or more layers such as, but not limited to, a conductive layer and an insulating layer. In such an example, the conductive layer defines conductive pads and patterns of traces and wires that connect the conductive pads.

In some embodiments, one or more electronic components may be soldered, fixed, or otherwise electronically coupled to one or more conductive pads, such that the one or more electronic components can be in electronic communications with one another. Examples of the electronic components include, but are not limited to, a main controller component, an analog-to-digital converter component, a device data communication component, and/or the like.

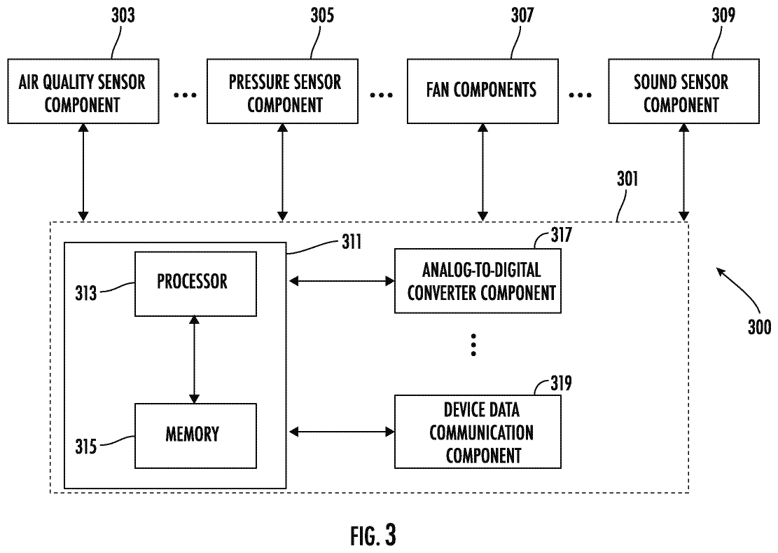

In some embodiments, a main controller component is electronically coupled to the circuit board component. For example, an example main controller component in accordance with some embodiments of the present disclosure may be in the form of a microcontroller or a microcontroller unit. In such an example, the pins of the microcontroller or the microcontroller unit can be securely connected and electronically coupled to the conductive pads of the circuit board component. Additional details associated with the main controller component are described herein, including, but not limited to, those described in connection with at least FIG. 3.

Additionally, or alternatively, an analog-to-digital converter component is electronically coupled to the circuit board component. For example, an example analog-to-digital converter component in accordance with some embodiments of the present disclosure may be in the form of an analog-to-digital converter (ADC) that converts an analog signal into a digital signal. Additional details associated with the analog-to-digital converter component are described herein, including, but not limited to, those described in connection with at least FIG. 3.

Additionally, or alternatively, a device data communication component is electronically coupled to the circuit board component. For example, an example device data communication component in accordance with some embodiments of the present disclosure may be in the form of semiconductor integrated circuits (IC) that may comprise one or more transmitters and/or one or more receivers. In some embodiments, an example device data communication component may support one or more data communication protocols, including, but not limited to, those described in connection with at least FIG. 3.

While the description above provides an example of a circuit board component and example components that are securely connected and/or electronically coupled to an example circuit board component, it is noted that the scope of the present disclosure is not limited to the description above. For example, an example mask component may comprise only one circuit board component. Additionally, or alternatively, an example circuit board component may comprise more than one PCB. Additionally, or alternatively, an example circuit board component may connect one or more other electronic components.

In some embodiments, an example fan component may comprise an electric fan. In some embodiments, each of one or more fan components of the mask component is disposed in the space that is defined by an inner shell indentation portion of the inner shell component and the outer shell component.

For example, the mask component 200 comprises a fan component 214A and a fan component 214B. In some embodiments, the fan component 214A may be disposed on the right side of the mask component 200 and in the space that is defined by the inner shell indentation portion 220A of the inner shell component 216 and the outer shell component 206. In some embodiments, the fan component 214B may be disposed on the left side of the mask component 200 and in the space that is defined by the inner shell indentation portion 220B of the inner shell component 216 and the outer shell component 206.

While the description above provides an example mask component comprising two fan components, it is noted that the scope of the present disclosure is not limited to the description above. In some examples, an example mask component may comprise less than two or more than two fan components.

In some embodiments, an example fan component may operate at different rotation speeds. For example, the example fan component may be in the form of a stepped fan that provides different, predetermined settings for the rotation speeds. Additionally, or alternatively, the example fan component may be in the form of a stepless fan that enables continuous adjustment of the rotation speed.

In some embodiments, an example fan component may operate at different rotational directions. For example, the example fan component may operate in a forward direction or a reverse direction. As an example, when the example fan component operates in the forward rotational direction, the electric fan of the example fan component may rotate counter-clockwise (when viewing from a user wearing the mask component 200) and/or may operate as a blower that draws air from outside the mask component 200 to inside the mask component 200. As another example, when the example fan component operates in the reverse rotational direction, the example fan component may rotate clockwise (when viewing from a user wearing the mask component 200) and/or may operate as an exhaust/ventilation fan that draws air from inside the mask component 200 to outside the mask component 200.

In some embodiments, the one or more fan components are electronically coupled to the main controller component on the example circuit board component, such that the one or more fan components and the main controller component are in data communications with one another.

In some embodiments, various operation parameters of the fan components (such as, but not limited to, the start time, the stop time, the rotational directions (e.g. forward direction or reverse direction) and/or the rotation speed) may be controlled and/or adjusted by the main controller component.

For example, the main controller component may transmit a fan component activation signal to the fan component that causes the fan component to start operating (e.g. causes the electric fan to start rotating). In some embodiments, the fan component activation signal comprises a rotation speed value that indicates the speed for the fan component.

Additionally, or alternatively, the main controller component may transmit a fan component deactivation signal to the fan component that causes the fan component to stop operating (e.g. causes the electric fan to stop rotating).

Additionally, or alternatively, the main controller component may transmit a forward rotation start signal to a fan component that causes the fan component to start forward rotation (e.g. start operating as a blower that draws air from outside the mask component 200 towards inside the mask component 200). In some embodiments, the forward rotation start signal may include a forward rotation speed value that indicates the speed for the fan component. Additionally, or alternatively, the main controller component may transmit a forward rotation stop signal to the fan component that causes the fan component to stop forward rotation.

Additionally, or alternatively, the main controller component may transmit a reverse rotation start signal to a fan component that causes the fan component to start reverse rotation (e.g. start operating as an exhaust fan that draws air from inside the mask component 200 towards outside the mask component 200). In some embodiments, the reverse rotation start signal may include a reverse rotation speed value that indicates the speed for the fan component. Additionally, or alternatively, the main controller component may transmit a reverse rotation stop signal to the fan component that causes the fan component to stop reverse rotation.

In some embodiments, various operation parameters of the fan components (such as, but not limited to, the start time, the stop time, the rotational directions (e.g. forward direction or reverse direction) and/or the rotation speed) may be read or determined by the main controller component.

For example, the main controller component may receive one or more fan speed signals from the one or more fan components. In such an example, each of the one or more fan speed signals comprises a rotation speed indication associated with the corresponding fan component, and the rotation speed indication indicates a current rotation speed of the electric fan of the fan component.

In some embodiments, the power charging component 212A is electronically coupled to one or more electronic components on the circuit board component 210A (such as, but not limited to, the main controller component) and to one or more fan components (such as, but not limited to, the fan component 214A and the fan component 214B). In some embodiments, the power charging component 212A may provide power to the one or more electronic components on the circuit board component 210A (such as, but not limited to, the main controller component) and to one or more fan components (such as, but not limited to, the fan component 214A and the fan component 214B).

For example, the power charging component 212A may comprise a device power source component.

In some embodiments, the device power source component refers to an electronic component that provides a source of electrical energy. In some embodiments, an example device power source component in accordance with some embodiments of the present disclosure may be in the form of, such as but not limited to, one or more batteries, one or more supercapacitors, one or more ultracapacitors, and/or the like.

In some embodiments, the device power source component is electronically coupled to one or more other electronic components associated with the respiratory protective device (such as, but not limited to, the main controller component). In such examples, the device power source component provides electrical energy to these other electronic components.

In some embodiments, the example device power source component is rechargeable. For example, an example device power source component in accordance with some embodiments of the present disclosure can be recharged through, for example, a wireless charger circuit, a Universal Serial Bus (USB) charger circuit, an integrated circuit (IC) battery charger circuit, and/or the like.

Additionally, in some embodiments, the power charging component 212A may comprise the device power source component and a power charging circuit component.

In some embodiments, the device power source component can charge other electronic components through the charging circuit component. For example, the power charging circuit component may be electronically coupled to the device power source component and one or more other electronic components that are associated with the respiratory protective device (such as, but not limited to, the main controller component). In such an example, the power charging circuit component transfers electrical energy from the device power source component to the one or more other electronic components. In some embodiments, the power charging circuit component optimizes the electrical energy from the device power source component for consumption by other electronic components. For example, the power charging circuit component may comprise one or more voltage regulators so that a constant voltage can be provided to other electronic components. Additionally, or alternatively, the power charging circuit component may comprise one or more voltage divider circuits so that a suitable voltage can be provided to other electronic components.

While the description above provides example components (such as, but not limited to, circuit board components, fan components, and power charging components) that are housed, disposed, or positioned within the space formed by the indentation portions of the inner shell component 216 and the outer shell component 206, it is noted that the scope of the present disclosure is not limited to the examples above. In some embodiments, circuit board components, fan components, and/or power charging components may be disposed or positioned outside the space formed by the indentation portions of the inner shell component 216 and the outer shell component 206. In some embodiments, one or more other components may additionally or alternatively be housed, disposed, or positioned within the space formed by the indentation portions of the inner shell component 216 and the outer shell component 206.

Referring back to FIG. 2B, the mask component 200 may comprise one or more key components such as, but not limited to, a key component 236A, a key component 236B, and a key component 236C. In some embodiments, the one or more key components may be disposed on an outer surface of the outer shell component 206. In some embodiments, each of the one or more key components may provide a button that allows a user to control and/or adjust the operations of various electronic components described herein (such as, but not limited to, fan components, earpieces, and/or the like).

In some embodiments, when the mask component 200 is worn by a user, the user can inhale through the mask component 200. In some embodiments, the air inhaled by the user is filtered by one or more inhalation filtration components.

For example, the mask component 200 may comprise one or more inhalation filtration components (such as, but not limited to, inhalation filtration component 204A and inhalation filtration component 204B). In some embodiments, each of the one or more inhalation filtration components may comprise a filter media element that comprise filter material for filtering air. Examples of filter material include, but are not limited to, high efficiency particulate air (HEPA) filters.

While the description above provides an example mask component comprising two inhalation filtration components, it is noted that the scope of the present disclosure is not limited to the description above. In some examples, an example mask component may comprise less than two or more than two inhalation filtration components.

In some embodiments, the mask component 200 comprises one or more puck components (such as, but not limited to, puck component 202A and puck component 202B). In some embodiments, each of the one or more puck components may be positioned to cover one of the inhalation filtration components so as to prolong the lifespan of the mask component 200. For example, the puck component 202A may cover the inhalation filtration component 204A, and the puck component 202B may cover the inhalation filtration component 204B.

In some embodiments, the one or more inhalation filtration components (such as, but not limited to, inhalation filtration component 204A and inhalation filtration component 204B) are disposed in the outer shell indentation portion(s) of the outer shell component 206.

For example, as shown in FIG. 2C, the outer shell component 206 of the example mask component 200 may comprise one or more outer shell indentation portions (such as, but not limited to, the outer shell indentation portion 209A). In some embodiments, each of the outer shell indentation portions (such as the outer shell indentation portion 209A) may be sunken or depressed from the outer surface of the outer shell component 206. In the example shown in FIG. 2C, an inhalation filtration component 204A is disposed in the outer shell indentation portion 209A of the outer shell component 206.

In some embodiments, each of the one or more outer shell indentation portions may comprise an air inlet opening. In the example shown in FIG. 2C, the outer shell indentation portion 209A of the outer shell component 206 comprises the air inlet opening 208A.

In some embodiments, each of the one or more inhalation filtration components (that are disposed in an outer shell indentation portion of an outer shell component) is positioned to at least partially or fully cover an air inlet opening of the outer shell indentation portion. In the example shown in FIG. 2C, the inhalation filtration component 204A is positioned on the outer shell indentation portion 209A of the outer shell component 206 and at least partially covers the air inlet opening 208A of the outer shell indentation portion 209A. As such, air may flow through the inhalation filtration component 204A and be released through the air inlet opening 208A of the outer shell indentation portion 209A.

As described above, an example mask component may comprise one or more fan components that are each disposed on an inner shell indentation portion of the inner shell component 216. In some embodiments, when the mask component 200 is assembled, the outer shell component 206 is secured to the inner shell component 216. In the example shown in FIG. 2B and FIG. 2C, a fan inlet of the fan component 214A (disposed on the inner shell indentation portion of the inner shell component 216) is aligned within the air inlet opening 208A (on the outer shell indentation portion 209A of the outer shell component 206). As such, air may flow from the air inlet opening 208A of the outer shell indentation portion 209A to the input opening of the fan component 214A.

In the present disclosure, a fan component may comprise a fan inlet and a fan outlet. In some embodiments, when the fan component operates, the fan component draws air in from the fan inlet and pushes air out through the fan outlet.

For example, an example fan component in accordance with some embodiments of the present disclosure may be in the form of a centrifugal fan. In such an example, the example fan component comprises impellers in the form of a rotating wheel of blades. When the impellers rotate, the impellers drag air in through the fan inlet and cause the air to enter into circular motions. The circular motions in turn create centrifugal force, which pushes air out from the fan component through the fan outlet.

While the description above provides an example centrifugal fan as an example fan component, it is noted that the scope of the present disclosure is not limited to the description above. In some examples, an example fan component may be in one or more additional and/or alternative forms.

As described above, an example mask component may comprise one or more fan components that are each disposed on an inner shell indentation portion of the inner shell component 216. In some embodiments, each of the one or more inner shell indentation portions of the inner shell component 216 may comprise one or more air inlet slots. In some embodiments, the one or more fan outlet(s) of the one or more fan components are each aligned with one of the one or more air inlet slots on the inner shell component 216.

For example, in the example shown in FIG. 2C, the inner shell indentation portion 220A comprises air inlet slots 222A on the bottom surface of the inner shell indentation portion 220A. In some embodiments, the fan outlet of the fan component 214A is aligned with the air inlet slots 222A. As such, the fan component 214A pushes air out from the fan outlet and through the air inlet slots 222A of the inner shell indentation portion 220A.

While the description above describes example air inlet slots that are disposed on the bottom surface of the inner shell indentation portion of the inner shell component, it is noted that the scope of the present disclosure is not limited to the description above. In some examples, one or more air inlet slots may be additionally or alternatively disposed on the side surfaces of the inner shell indentation portion of the inner shell component.

In accordance with some embodiments of the present disclosure, example fan components in the mask component can facilitate the user's breathing.

For example, when the user inhales, the fan component 214A may operate in a forward direction that draws air from outside the mask component 200 towards inside the mask component 200. In this example, the fan component 214A drags air from the outside environment through the inhalation filtration component 204A, then through the air inlet opening 208A on the outer shell indentation portion 209A of the outer shell component 206, and then into the fan inlet of the fan component 214A. Continuing this example, the fan component 214A pushes air out from the fan outlet of the fan component 214A, then through the air inlet slots 222A of the inner shell indentation portion 220A, and then into the space between the user's face and the mask component 200. In some embodiments, the fan component 214A can increase the volume and/or the flow rate of air entering the space between the user's face and the mask component 200, thereby facilitating the inhalation of the user.

In some embodiments, when the mask component 200 is worn by a user, the user can exhale through the mask component 200. In some embodiments, the air exhaled by the user is filtered by one or more exhalation filtration components.

For example, referring now to FIG. 2D, an example back view of the example mask component 200 is illustrated. In particular, FIG. 2D illustrates the inner surface of the inner shell component 216 when the example mask component 200 is worn by a user.

In the example shown in FIG. 2D, the example mask component 200 may comprise air inlet slots that are located on the middle right side of the inner shell component 216 (for example, air inlet slots 222A) and/or air inlet slots that are located on the middle left side of the inner shell component 216 (for example, air inlet slots 222B).

In some embodiments, the inner surface 232 of the inner shell component 216 may comprise a nose portion 234, which is located close to a user's nose when the user wears the mask component 200. In this example, the air inlet slots 222A may be located to the right of the nose portion 234, and the air inlet slots 222B may be located to the left of the nose portion 234.

In some embodiments, the example mask component 200 may comprise an outlet opening 224 that is on a middle bottom portion of the inner shell component 216. In some embodiments, the outlet opening 224 may be located corresponding to the position of the user's mouth. For example, when a user exhales, the breath may be released through the outlet opening 224.

As shown in FIG. 2A to FIG. 2C, an exhalation filtration component 226 may be connected to the inner shell component 216 at the outlet opening 224. For example, the exhalation filtration component 226 may cover the outlet opening 224. In some embodiments, the exhalation filtration component 226 may comprise a filter media element that comprises filter material for filtering air. Examples of filter material include, but are not limited to, HEPA filters. As such, the breath that is exhaled by the user may be filtered before it is released from inside the mask component 200 to the outside environment.

In accordance with some embodiments of the present disclosure, various sensor components may be implemented in the example mask component 200 to detect, generate, and determine one or more operational signals associated with the example mask component 200.

For example, an example mask component in accordance with some embodiments of the present disclosure may comprise one or more pressure sensor components. For example, when the mask component 200 is worn by a user, the face seal component 218 and an inner surface 232 of the inner shell component 216 create an enclosed space on at least a portion of the user's face (e.g. on the mouth, nostrils, etc.). In some embodiments, a pressure sensor component may comprise a pressure sensor that detects the air pressure within this enclosed space. Examples of the pressure sensor components include, but are not limited to, resistive air pressure transducer or strain gauge, capacitive air pressure transducer, inductive air pressure transducer, and/or the like. In the example shown in FIG. 2A, a pressure sensor component 228A may be disposed on an inner surface of the inner shell component 216. Additionally, or alternatively, as shown in FIG. 2C, a pressure sensor component 228B may be disposed on the inner shell indentation portion 220A of the inner shell component 216. Additionally, or alternatively, as shown in FIG. 2D, a pressure sensor component 228C may be disposed on the inner surface of the inner shell component 216. In some embodiments, the pressure sensor component 228A, the pressure sensor component 228B, and/or the pressure sensor component 228C may detect the air pressure within the enclosed space defined by the face seal component 218 and the inner shell component 216 on at least a portion of the user's face.

Additionally, or alternatively, an example mask component in accordance with some embodiments of the present disclosure may comprise one or more humidity sensor components and/or one or more air quality sensor components.

In some embodiments, the mask component 200 comprises a humidity sensor component 230 that is disposed in the exhalation filtration component 226 and at least partially covers the outlet opening 224 of the inner shell component 216. In some embodiments, the humidity sensor component 230 may comprise a humidity sensor that may, for example but not limited to, detect humidity levels within the enclosed space and/or in the breath exhaled by the user. Examples of the humidity sensor component 230 include, but are not limited to, capacitive humidity sensors, resistive humidity sensors, thermal humidity sensors, and/or the like.

In some embodiments, the mask component 200 comprises an air quality sensor component in addition to or in alternative of the humidity sensor component 230. For example, the air quality sensor component may be disposed in the exhalation filtration component 226 and at least partially covers the outlet opening 224 of the inner shell component 216. In some embodiments, the air quality sensor component may comprise an air quality sensor that may, for example but not limited to, determine the air quality levels within the enclosed space and/or in the breath exhaled by the user. Examples of the air quality sensor component include, but are not limited to, volatile organic compounds (VOC) sensors, oxygen sensors, carbon dioxide sensors, and/or the like.

Additionally, or alternatively, an example mask component in accordance with some embodiments of the present disclosure may comprise one or more device sound sensor components. In some embodiments, an example device sound sensor component comprises a sound sensor that converts sound waves into electrical signals. Examples of device sound sensor components include, but are not limited to, microphones, acoustic sensors, noise sensors, and/or the like.

In some embodiments, the one or more device sound sensor components are disposed on an inner surface of the inner shell component 216. For example, referring now to FIG. 2D, an example device sound sensor component 238 is disposed on the inner surface 232 of the inner shell component 216. Additionally, or alternatively, one or more sound sensor components may be disposed at one or more locations in addition to or in alternative of the example shown in FIG. 2D.

While the description above provides example sensor components in an example mask component, it is noted that the scope of the present disclosure is not limited to the description above. For example, an example mask component may comprise one or more additional and/or alternative sensor components.

Referring now to FIG. 3, an example circuit diagram of an example respiratory protective device 300 in accordance with some example embodiments described herein is illustrated. In particular, FIG. 3 illustrates example electronic components of an example respiratory protective device 300 in accordance with various example embodiments of the present disclosure.

As shown in FIG. 3, the example respiratory protective device 300 may comprise a circuit board component 301 that is electronically coupled to one or more sensor components (such as, but not limited to, the air quality sensor component 303, the pressure sensor component 305), one or more fan components (such as the fan component 307), the device sound sensor component 309, and/or the like.

As described above, the one or more electronic components are electronically coupled to the circuit board component 301. In the example shown in FIG. 3, the one or more electronic components comprise a main controller component 311, an analog-to-digital converter component 317, a device data communication component 319, and/or the like.

In the example shown in FIG. 3, the main controller component 311 comprises a processor 313 and a memory 315.

In some embodiments, the processor 313 (and/or co-processor or any other processing circuitry assisting or otherwise associated with the processor) may be in communication with the memory 315 via a bus for passing information among components of the apparatus. The memory 315 may be non-transitory and may include, for example, one or more volatile and/or non-volatile memories. In other words, for example, the memory 315 may be an electronic storage device (e.g., a computer readable storage medium). The memory 315 may be configured to store information, data, content, applications, instructions, and/or the like, for enabling the main controller component 311 to carry out various functions in accordance with example embodiments of the present disclosure.

In some embodiments, the processor 313 may be embodied in a number of different ways and may, for example, include one or more processing devices configured to perform independently. Additionally, or alternatively, the processor 313 may include one or more processors configured in tandem via a bus to enable independent execution of instructions, pipelining, and/or multithreading.

For example, the processor 313 may be embodied as one or more complex programmable logic devices (CPLDs), microprocessors, multi-core processors, co-processing entities, application-specific instruction-set processors (ASIPs), and/or controllers. Further, the processor 313 may be embodied as one or more other processing devices or circuitry. The term circuitry may refer to an entirely hardware embodiment or a combination of hardware and computer program products. Thus, the processor 313 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor 313 may be configured for a particular use or configured to execute instructions stored in volatile or non-volatile media or otherwise accessible to the processor 313. As such, whether configured by hardware or computer program products, or by a combination thereof, the processor 313 may be capable of performing steps or operations according to embodiments of the present invention when configured accordingly.

The use of the terms “processing circuitry” or “processor” may be understood to include a single core processor, a multi-core processor, multiple processors internal to the apparatus, and/or remote or “cloud” processors.

In some embodiments, the memory 315 stores non-transitory program codes or non-transitory program instructions. In some embodiments, the memory 315 may comprise volatile storage or memory such as, but not limited to, random-access memory (RAM), dynamic random access memory (DRAM), static random access memory (SRAM), fast page mode dynamic random access memory (FPM DRAM), extended data out DRAM (EDO DRAM), synchronous DRAM (SDRAM), double data rate SDRAM (DDR SDRAM), double data rate 2 SDRAM (DDR2 SDRAM), double data rate 3 SDRAM (DDR3 SDRAM), Rambus DRAM (RDRAM), Rambus inline memory module (RIMM), dual in-line memory module (DIMM), single in-line memory module (SIMM), video random access memory (VRAM), cache memory, register memory, and/or the like. Additionally, or alternatively, the memory 315 may comprise non-volatile storage or memory such as, but not limited to, hard disks, read-only memory (ROM), programmable ROM (PROM), erasable programmable ROM (EPROM), electrically erasable programmable ROM (EEPROM), flash memory, SD memory cards, Memory Sticks, conductive-bridging RAM (CBRAM), parameter RAM (PRAM), ferroelectric RAM (FeRAM), resistive RAM (RRAM), SONOS, racetrack memory, and/or the like. Additionally, or alternatively, the memory 315 may store databases, database instances, database management system entities, data, applications, programs, program modules, scripts, source code, object code, byte code, compiled code, interpreted code, machine code, executable instructions, and/or the like. The term database, database instance, database management system entity, and/or similar terms used herein interchangeably and in a general sense to refer to a structured or unstructured collection of information/data that is stored in a computer-readable storage medium.

In some embodiments, the processor 313 may be configured to execute instructions stored in the memory 315 or otherwise accessible to the processor. Alternatively, or additionally, the processor 313 may be configured to execute hard-coded functionality. As such, whether configured by hardware or software methods, or by a combination thereof, the processor 313 may represent an entity (e.g., physically embodied in circuitry) capable of performing operations according to an embodiment of the present disclosure while configured accordingly. Additionally, or alternatively, when the processor 313 is embodied as an executor of software instructions, the instructions may specifically configure the processor to perform the algorithms and/or operations described herein when the instructions are executed.

In some embodiments, the memory 315 and the non-transitory program code are configured to, with the processor 313, cause the main controller component 311 to execute one or more methods and/or operations of method(s) described herein. Although the components are described with respect to functional limitations, it should be understood that the particular implementations necessarily include the use of particular hardware. It should also be understood that certain of the components described herein may include similar or common hardware. For example, two sets of circuitries may both leverage use of the same processor, network interface, storage medium, or the like to perform their associated functions, such that duplicate hardware is not required for each set of circuitries. The use of the term “circuitry” as used herein with respect to components of the apparatus should therefore be understood to include particular hardware configured to perform the functions associated with the particular circuitry as described herein.

In some embodiments, the main controller component 311 is electronically coupled to one or more other electronic components on the circuit board component 301. In the example shown in FIG. 3, the main controller component 311 is electronically coupled to, such as but not limited to, the analog-to-digital converter component 317 and the device data communication component 319.

In some embodiments, the analog-to-digital converter component 317 translates/converts analog signals from other components into digital signals for the main controller component 311. For example, the analog-to-digital converter component 317 converts, such as but not limited to, signals from the air quality sensor component 303, signals from the pressure sensor component 305, signals from the fan component 307, signals from device sound sensor component 309, and/or the like. Examples of the analog-to-digital converter component 317 include, but not limited to, successive approximation (SAR) analog-to-digital converters, delta-sigma analog-to-digital converters, dual slope analog-to-digital converters, pipelined analog-to-digital converters, and/or the like.

In some embodiments, the device data communication component 319 may be any means such as a device or circuitry embodied in either hardware or a combination of hardware and software that is configured to receive and/or transmit data from/to a network and/or any other device, circuitry, or module in communication with the main controller component 311. In this regard, the device data communication component 319 may include, for example, a network interface for enabling communications with a wired or wireless communication network. For example, the device data communication component 319 may include one or more network interface cards, antennae, buses, switches, routers, modems, and supporting hardware and/or software, or any other device suitable for enabling communications via a network. Additionally, or alternatively, the device data communication component 319 may include the circuitry for interacting with the antenna/antennae to cause transmission of signals via the antenna/antennae or to handle receipt of signals received via the antenna/antennae.

In some embodiments, the device data communication component 319 communicates data, content, information, and/or similar terms used herein interchangeably that can be transmitted, received, operated on, processed, displayed, stored, and/or the like to and/or from the main controller component 311.

In some embodiments, such communications can be executed by using any of a variety of wireless communication protocols such as, but not limited to, Bluetooth protocols, near field communication (NFC) protocols, general packet radio service (GPRS), Universal Mobile Telecommunications System (UMTS), Code Division Multiple Access 1900 (CDMA1900), CDMA1900 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), Institute of Electrical and Electronics Engineers (IEEE) 802.11 (Wi-Fi), Wi-Fi Direct, 802.16 (WiMAX), ultra-wideband (UWB), infrared (IR) protocols, Wibree, wireless universal serial bus (USB) protocols, and/or any other wireless protocol.

Additionally, or alternatively, such communications can be executed by using any of a variety of wired communication protocols, but not limited to, such as fiber distributed data interface (FDDI), digital subscriber line (DSL), Ethernet, asynchronous transfer mode (ATM), frame relay, data over cable service interface specification (DOCSIS), or any other wired transmission protocol.

In accordance with some embodiments of the present disclosure, one or more electronic components in the example mask component (such as, but not limited to, sensor components, fan components, and/or the like) are electronically coupled to one or more electronic components on the circuit board component 301 (such as, but not limited to, the main controller component 311, the analog-to-digital converter component 317, the device data communication component 319, and/or the like).

In some embodiments, the one or more electronic components in the example mask component are electronically coupled to the one or more electronic components on the circuit board component 301 through wired means, and can transmit data to and receive data from electronic components on the circuit board component 301 (such as, but not limited to, the main controller component 311, the analog-to-digital converter component 317, the device data communication component 319, and/or the like). Additionally, or alternatively, the one or more electronic components in the example mask component are electronically coupled to the one or more electronic components on the circuit board component 301 through wireless means.

In the example shown in FIG. 3, one or more pressure sensor components (such as, but not limited to, the pressure sensor component 305) are in electronic communication with the circuit board component 301 (such as, but not limited to, the main controller component 311, the analog-to-digital converter component 317, the device data communication component 319, and/or the like). For example, the pressure sensor component 305 may transmit air pressure indications indicating the detected air pressure to the main controller component 311 or the analog-to-digital converter component 317. In some embodiments, each of the air pressure indications may comprise an air pressure value that corresponds to the air pressure in the enclosed space as defined by the face seal component 218 and the inner shell component 216.

Additionally, or alternatively, the one or more humidity sensor components and/or one or more air quality sensor components (such as, but not limited to, the air quality sensor component 303) are in electronic communication with the circuit board component 301 (such as, but not limited to, the main controller component 311, the analog-to-digital converter component 317, the device data communication component 319, and/or the like). For example, each of the one or more humidity sensor components can transmit humidity indications indicating the detected humidity levels (for example, relative humidity levels) to the main controller component 311 or the analog-to-digital converter component 317. Additionally, or alternatively, each of the one or more air quality sensor components can transmit air quality indications (such as, but not limited to, VOC concentration indications, oxygen concentration indications, carbon dioxide concentration indications, and/or the like) to the main controller component 311 or the analog-to-digital converter component 317.

Additionally, or alternatively, the one or more device sound sensor components (such as, but not limited to, the device sound sensor component 309) are in electronic communication with the circuit board component 301 (such as, but not limited to, the main controller component 311, the analog-to-digital converter component 317, the device data communication component 319, and/or the like). For example, each of the one or more device sound sensor components can generate and transmit sound signals to the main controller component 311, the analog-to-digital converter component 317, and/or the device data communication component 319).

Additionally, or alternatively, the one or more fan components (such as, but not limited to, the fan component 307) are in electronic communication with the circuit board component 301 (such as, but not limited to, the main controller component 311, the analog-to-digital converter component 317, the device data communication component 319, and/or the like). For example, each of the one or more fan components can generate and transmit fan speed signals (e.g. comprising a rotation speed indication associated with the corresponding fan component) to the main controller component 311, the analog-to-digital converter component 317, and/or the device data communication component 319.

While the description above provides example sensor components that are in data communications with the main controller component, it is noted that the scope of the present disclosure is not limited to the description above. In some examples, one or more other sensor components may additionally or alternatively be in electronic communications with the main controller component.

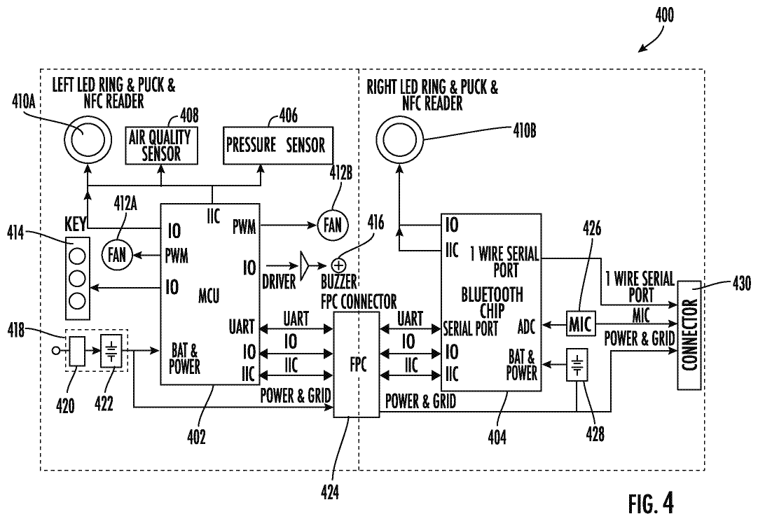

Referring now to FIG. 4, an example circuit diagram illustrating example components of an example respiratory protective device 400 in accordance with some example embodiments is illustrated. In the example shown in FIG. 4, the example respiratory protective device 400 comprises a main controller component 402, similar to the example main controller components described above.

In some embodiments, the main controller component 402 is electronically coupled to one or more other electronic components. In the example shown in FIG. 4, the main controller component 402 is electronically coupled to components such as, but not limited to, a pressure sensor component 406, an air quality sensor component 408, one or more light components (such as, but not limited to, a light component 410A and a light component 410B), one or more fan components (such as, but not limited to, a fan component 412A and a fan component 412B), the key components 414, and/or the buzzer circuit 416.

In some embodiments, the pressure sensor component 406 may transmit air pressure indications to the main controller component 402. As described above, each of the air pressure indications may comprise an air pressure value that corresponds to the air pressure in the enclosed space as defined by the face seal component 218 and the inner shell component 216.

In some embodiments, the air quality sensor component 408 may transmit air quality indications to the main controller component 402. As described above, the air quality indications may indicate for example, but not limited to, VOC concentration indications, oxygen concentration indications, carbon dioxide concentration indications, and/or the like.

While the description above provides an example air quality sensor component, it is noted that the scope of the present disclosure is not limited to the description above. In some examples, one or more humidity sensor components are electronically coupled to the main controller component 402 in addition to or in alternative of the air quality sensor component. For example, each of the one or more humidity sensor components may generate humidity indications that indicate relative humidity levels within the enclosed space defined by the face seal component and the inner shell component of the respiratory protective device on at least a portion of the user's face, similar to those described above.

In some embodiments, each of the one or more the light components (such as, but not limited to, the light component 410A and the light component 410B) may be in the form of one or more light-emitting diode (LED) rings that are disposed on one or more puck components (for example, on the left puck component and the right puck component). For example, the light component 410A may be disposed on the left puck component and the light component 410B may be disposed on the right puck component. In some embodiments, the main controller component 402 may transmit control signals to the one or more light components so as to adjust the color and/or intensity of light emitted by the one or more light components.

In some embodiments, each of the one or more fan components (such as, but not limited to, the fan component 412A and/or the fan component 412B) can generate and transmit fan speed signals (e.g., comprising a rotation speed indication associated with the corresponding fan component) to the main controller component 402. In some embodiments, the main controller component may transmit a fan component activation signal to a fan component (e.g., the fan component 412A and/or the fan component 412B) that causes the fan component to start operating In some embodiments, the main controller component may transmit a fan component deactivation signal to the fan component that causes a fan component (e.g., the fan component 412A and/or the fan component 412B) to stop operating. In some embodiments, the main controller component may transmit a forward rotation start signal to a fan component (e.g., the fan component 412A and/or the fan component 412B) that causes the fan component to start forward rotation. In some embodiments, the main controller component may transmit a reverse rotation start signal to a fan component (e.g., the fan component 412A and/or the fan component 412B) that causes the fan component to start reverse rotation.

In some embodiments, the main controller component 402 is in electronic communications with the key components 414. For example, when a user presses a button on the key components 414, the key components 414 may transmit a corresponding signal to the main controller component 402. In such an example, based on which button that the user presses, the main controller component 402 triggers one or more operations associated with other components of the respiratory protective device 400 and/or one or more earpiece devices associated with the respiratory protective device 400 (such as, but not limited to, adjusting the volume, triggering noise canceling mode, and/or the like).

In some embodiments, the main controller component 402 is in electronic communication with the buzzer circuit 416. For example, the main controller component 402 may transmit control signals to the buzzer circuit 416 so as to trigger an alarm sound.

In some embodiments, the respiratory protective device 400 comprises a power charging component 418. In the example shown in FIG. 4, the power charging component 418 comprises a device power source component 420 and a power charging circuit component 422.

Similar to those described above, the device power source component 420 may be in the form of, such as but not limited to, one or more batteries. In some embodiments, the power charging circuit component 422 may be electronically coupled to the device power source component 420 and the main controller component 402. In such an example, the power charging circuit component 422 transfers electrical energy from the device power source component 420 to the main controller component 402. For example, the power charging circuit component 422 may comprise one or more voltage regulators so that a constant voltage can be provided to the main controller component 402. Additionally, or alternatively, the power charging circuit component 422 may comprise one or more voltage divider circuits so that a suitable voltage can be provided to the main controller component 402.

In some embodiments, subsequent to receiving electrical energy from the device power source component 420 and/or the power charging circuit component 422, the main controller component 402 transfers electrical energy to other electronic components (such as, but not limited to, the fan component 412A, the fan component 412B, and/or the like).

In some embodiments, the example respiratory protective device 400 comprises a device data communication component 404.

In the example shown in FIG. 4, the main controller component 402 and the device data communication component 404 may be secured to different circuit board components.

For example, the main controller component 402 may be secured to a circuit board component that is disposed on an inner shell indentation portion that is on a left side of the inner shell component, and the device data communication component 404 may be secured to a circuit board component that is that is disposed on an inner shell indentation portion that is on a right side of the inner shell component. In such an example, the circuit board component where the main controller component 402 is secured is also referred to as the “main board,” and the circuit board component where the device data communication component 404 is secured is referred to as the “audio board.”

In some embodiments, the two circuit board components are connected through flexible printed circuit (FPC) connectors 424. For example, the main controller component 402 is electronically coupled to a first FPC connector that is secured to the same circuit board component as that of the main controller component 402, and the device data communication component 404 is electronically coupled to a second FPC connector that is secured to the same circuit board component as that of the device data communication component 404. In such an example, the first FPC connector is electronically coupled to the second FPC connector so that the main controller component 402 and the device data communication component 404 are electronically coupled to one another. For example, the FPC connectors 424 can enable device-to-device digital communications (for example, based on universal asynchronous receiver/transmitter (UART) protocols, Inter-Integrated Circuit (I2C) protocols, and/or the like) between the main controller component 402 and the device data communication component 404, input/output (I/O) signal exchanges between the main controller component 402 and the device data communication component 404, electrical energy transfer between the main controller component 402 and the device data communication component 404, and/or the like.

While the description above provides an example of two circuit board components, it is noted that the scope of the present disclosure is not limited to an example respiratory protective device comprising two circuit board components. In some examples, an example respiratory protective device may comprise only one circuit board component, where both a main controller component and a device data communication component are secured. In some embodiments, an example respiratory protective device may comprise more than two circuit board components.

Similar to those described above, the device data communication component 404 comprises hardware or a combination of hardware and software that receives and/or transmits data from/to a network, any other device, circuitry, module, and/or the like. As an example, the device data communication component 404 may be in the form of a Bluetooth® chip that comprises a radio frequency (RF) transceiver for sending and receiving communications in the 2.4 GHZ industrial, scientific, and medical (ISM) radio frequency band. Additionally, or alternatively, the device data communication component 404 may be in other forms.

In some embodiments, the device data communication component 404 is electronically coupled to one or more other electronic components. In the example shown in FIG. 4, the device data communication component 404 is electronically coupled to components such as, but not limited to, a light component 410B, a device sound sensor component 426, a power charging circuit component 428, and an earpiece connector component 430.

In some embodiments, the light component 410B may be in the form of one or more light-emitting diode (LED) rings that are disposed on one or more puck components (for example, on the right puck component). In some embodiments, the main controller component 402 may transmit control signals to the light component 410B through the device data communication component 404 so as to adjust the color and/or intensity of the light emitted by the light component 410B.

In some embodiments, the device sound sensor component 426 can generate and transmit sound signals to the device data communication component 404, and/or to the main controller component 402 through the device data communication component 404. In some embodiments, the main controller component 402 may transmit control signals (such as, but not limited to, sound sensor activation signals) to the device sound sensor component 426 through the device data communication component 404.

In some embodiments, the power charging circuit component 428 may be electronically coupled to the device power source component 420 (for example, through the FPC connectors 424) and the device data communication component 404. In such an example, the power charging circuit component 428 transfers electrical energy from the device power source component 420 to the device data communication component 404. For example, the power charging circuit component 428 may comprise one or more voltage regulators so that a constant voltage can be provided to the device data communication component 404. Additionally, or alternatively, the power charging circuit component 428 may comprise one or more voltage divider circuits so that a suitable voltage can be provided to the device data communication component 404.

In some embodiments, the earpiece connector component 430 refers to an electronic component that enables one or more electronic components of the respiratory protective device 400 (such as, but not limited to, the main controller component 402, the device data communication component 404, and/or the like) to be electronically coupled or electronically decoupled from one or more earpiece devices.

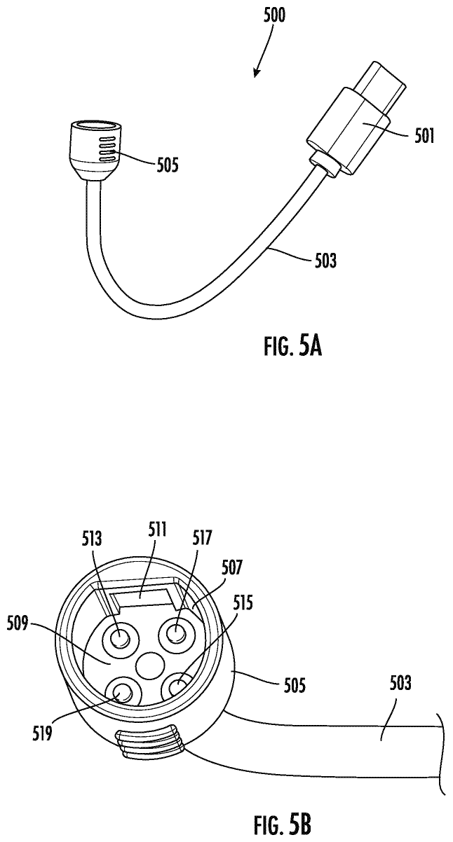

In some embodiments, an earpiece connector component comprises at least one power cable, at least one data cable, and an earpiece receptacle. Additional details associated with the earpiece connector component are provided herein, including, but not limited to, those described in connection with at least FIG. 5A and FIG. 5B.

In some embodiments, the earpiece connector component 430 is electronically coupled to one or more electronic components. In the example shown in FIG. 4, the earpiece connector component 430 is electronically coupled to the device data communication component 404 and device sound sensor component 426.

For example, the earpiece connector component 430 provides a serial communication port based on serial communication protocols for exchanging data communication signals between one or more earpiece devices and the respiratory protective device 400. For example, sound signals detected by the device sound sensor component 426 can be transmitted through the serial communication port of the earpiece connector component 430 to one or more earpiece devices. Additionally, or alternatively, sound signals detected by the earpiece sound sensor component of the earpiece device can be transmitted through the serial communication port of the earpiece connector component 430 to the main controller component 402. Additionally, or alternatively, the main controller component 402 can transmit one or more activation signals to various components of the earpiece device.

In some embodiments, the earpiece connector component 430 can transfer electrical energy from the power charging component 418 (for example, through the FPC connectors 424) to the one or more earpiece devices.

As described above, the main controller component 402 is electronically coupled to and in electronic communication with the device data communication component 404 through the FPC connectors 424. As such, the main controller component 402 is in electronic communication with the earpiece connector component 430.

Referring now to FIG. 5A and FIG. 5B, example views associated with an example earpiece connector component 500 of an example respiratory protective device in accordance with some embodiments of the present disclosure are provided.

In some embodiments, the earpiece connector component 500 comprises a connector plug 501. In the example shown in FIG. 5A, the connector plug 501 is in the form of a Universal Serial Bus (USB) Type-C plug. In such an example, the connector plug 501 comprises a 24-pin USC connector that transfers not only data communication signals, but also electrical energy (for example, electrical current) that enables device charging, details of which are described herein.

While the description above provides an example of a connector plug in the form of a USB Type-C plug, it is noted that the scope of the present disclosure is not limited to the description above. In some examples, an example connector plug may be in the form of one or more additional or alternative connector plugs that enable device-to-device communications.

In some embodiments, the earpiece connector component 500 is detachably connected to an example respiratory protective device. For example, the connector plug 501 of the earpiece connector component 500 is detachably connected to a connector receptacle disposed on an outer surface of the respiratory protective device.

For example, referring back to FIG. 1, an example connector receptacle 123 is disposed on an outer surface of the respiratory protective device 100. In some embodiments, the example connector receptacle 123 is disposed on the outer surface of the at least one non-elastic portion 119 of the strap component 103 of the respiratory protective device 100.

In some embodiments, the form of the example connector receptacle 123 is based on the form of the connector plug. As an example, the connector plug may be in the form of a USB Type-C connector plug as described above in connection with FIG. 5A. In such an example, the example connector receptacle 123 is in the form of a USB-C port.

In some embodiments, each of the one or more connector receptacles is electronically coupled to one or more electronic components of an example respiratory protective device (such has, but not limited to, the main controller component, the device data communication component, the device power source component, the device sound sensor component, and/or the like). As such, when the connector plug 501 of the earpiece connector component 500 is connected to the connector receptacle of the respiratory protective device, the earpiece connector component 500 is electronically coupled to one or more electronic components of the respiratory protective device (such has, but not limited to, the main controller component, the device data communication component, the device power source component, the device sound sensor component, and/or the like).

In some embodiments, an example respiratory protective device comprises two connector receptacles that are disposed on the different sides of the strap component of the respiratory protective device. For example, one connector receptacle is disposed adjacent to one of the car openings (for example, the car opening 105A as shown in FIG. 1), and the other connector receptacle is disposed adjacent to the other one of the ear openings (for example, the car opening 105B as shown in FIG. 1). In such embodiments, each of the connector receptacles is connected to a different connector plug of a different earpiece connector component.

Referring back to FIG. 5A, the earpiece connector component 500 comprises a cable outer jacket 503. In some embodiments, the cable outer jacket 503 is connected to the connector plug 501 of the earpiece connector component 500. In some embodiments, the cable outer jacket 503 comprises material(s) such as, but not limited to, plastic, rubber, and/or the like. In some embodiments, the cable outer jacket 503 provides an outer sheath for protecting one or more cables that are disposed within, including, but not limited to, at least one power cable, at least one data cable, and/or the like.

In some embodiments, the earpiece connector component 500 comprises at least one power cable. In some embodiments, the at least one power cable comprises conductive materials such as, but not limited to, copper, aluminum, and/or the like.

In some embodiments, the at least one power cable is electronically coupled to one or more pins of the connector plug 501 of the earpiece connector component 500. In some embodiments, when the connector plug 501 of the earpiece connector component 500 is connected to the connector receptacle of the respiratory protective device, one or more pins of the earpiece connector component 500 can be electronically coupled to the device power source component of the respiratory protective device as described above. In such examples, the at least one power cable is electronically coupled to the device power source component of the respiratory protective device.

In some embodiments, the earpiece connector component 500 comprises at least one data cable. In some embodiments, the at least one data cable comprises conductive materials such as, but not limited to, copper, aluminum, and/or the like.

In some embodiments, the at least one data cable is electronically coupled to one or more pins of the connector plug 501 of the earpiece connector component 500. In some embodiments, when the connector plug 501 of the earpiece connector component 500 is connected to the connector receptacle of the respiratory protective device, one or more pins of the earpiece connector component 500 is electronically coupled to one or more electronic components of the respiratory protective device (such as, but not limited to, the main controller component, the device data communication component, the device sound sensor component, and/or the like). In such examples, the at least one data cable is electronically coupled to the one or more electronic components of the respiratory protective device (such as, but not limited to, the main controller component, the device data communication component, the device sound sensor component, and/or the like).

In some embodiments, the earpiece connector component 500 comprises an earpiece receptacle 505. In some embodiments, the earpiece receptacle 505 may be in the form of a socket that is shaped to receive at least a portion of a respiratory protective device connector component of an earpiece device, details of which are described herein.

In the example shown in FIG. 5B, the earpiece receptacle 505 defines a socket inner side surface 507 and a socket base surface 509.

In some embodiments, the socket inner side surface 507 comprises a locking depression portion 511 that is sunken below the surrounding area. In some embodiments, when a respiratory protective device connector component of an earpiece device is inserted into the earpiece receptacle 505, the locking depression portion 511 engages with a locking protrusion portion on the respiratory protective device connector component of the earpiece device, additional details of which are described herein.

In some embodiments, the earpiece receptacle 505 comprises at least one power charging pin and at least one data transfer pin that are disposed on the socket base surface 509 of the earpiece receptacle 505.

In some embodiments, the at least one power charging pin is electronically coupled to the at least one power cable of the earpiece connector component 500. As described above, the at least one power cable is electronically coupled to the device power source component of the respiratory protective device. As such, the at least one power charging pin is electronically coupled to the device power source component of the respiratory protective device.

In the example shown in FIG. 5B, the earpiece receptacle 505 comprises a power charging pin 513 and a power charging pin 515. In such an example, one of the power charging pins (for example, the power charging pin 513) provides electrical energy from the device power source component of the respiratory protective device, and the other one of the power charging pins (for example, the power charging pin 515) provides ground signals.

In some embodiments, the at least one data transfer pin is electronically coupled to the at least one data cable of the earpiece connector component 500. As described above, the at least one data cable is electronically coupled to one or more electronic components of the respiratory protective device (such as, but not limited to, the main controller component, the device data communication component, the device sound sensor component, and/or the like). As such, the at least one data transfer pin is electronically coupled to one or more electronic components of the respiratory protective device (such as, but not limited to, the main controller component, the device data communication component, the device sound sensor component, and/or the like).

In the example shown in FIG. 5B, the earpiece receptacle 505 comprises a data transfer pin 517 and a data transfer pin 519. In such an example, one of the data transfer pins (for example, the data transfer pin 517) is electronically coupled to and exchange data communication signals with the device data communication component of the respiratory protective device based on the serial communication protocol, while the other of the data transfer pins (for example, the data transfer pin 519) is electronically coupled to the device sound sensor component of the respiratory protective device and receives sound signals.

In some embodiments, the earpiece connector component 500 provides earpiece connection signals to the main controller component of the respiratory protective device when an earpiece device is connected to the respiratory protective device through the earpiece connector component 500. In some embodiments, an example earpiece connection signal may be in the form of a power signal (e.g., an electric current signal, an electric voltage signal, and/or the like) indicating that the earpiece connector component 500 is electronically coupled to an earpiece device.

For example, the earpiece receptacle 505 of the earpiece connector component 500 may receive a respiratory protective device connector component of an earpiece device as described above. In some embodiments, the respiratory protective device connector component comprises at least one power connector contact. When the respiratory protective device connector component is inserted into the earpiece receptacle 505 of the earpiece connector component 500, the at least one power connector contact is electronically coupled to the at least one power charging pin of the earpiece connector component 500. As such, the earpiece connector component 500 creates a close circuit that electronically couples the respiratory protective device and the earpiece device, causing electrical energy to be transferred between the respiratory protective device and the earpiece device. For example, the earpiece device may provide a power signal to the respiratory protective device when the earpiece device is connected to the respiratory protective device. In such an example, the earpiece connector component 500 can provide an earpiece connection signal (for example, the power signal from the earpiece device) when the earpiece device is connected to the respiratory protective device.

While the description above provides an example of providing earpiece connection signals based on the power signals received at the power charging pin of the earpiece connector component, it is noted that the scope of the present disclosure is not limited to the description above. In some examples, earpiece connection signals may be provided based on other techniques.

The example earpiece connector component 500 shown in FIG. 5A and FIG. 5B provides various technical benefits and advantages.

For example, the example earpiece connector component 500 is detachable from a respiratory protective device. The example earpiece connector component 500 also comprises an earpiece receptacle that enables an earpiece device to be detachably connected to the example earpiece connector component 500. As such, the detachable earpiece device and the detachable earpiece connector component solves the technical problems associated with fixed earbuds and fixed connection cables that are described above.

As an example, many connectors (such as, but not limited to, USB standard B connectors) are too big to connect earpiece devices (many of which have small sizes). The example earpiece connector component 500 resolves these technical problems by incorporating four pins that not only enable data transfer with earpiece devices, but also power transfer with earpiece devices. In particular, the power charging pins of the example earpiece connector component 500 can provide power charging the earpiece devices, and the data transfer pins of the example earpiece connector component 500 can provide data transfer between the respiratory protective device and the earpiece device through serial communications. In some embodiments, by implementing serial communications between the respiratory protective device and the earpiece device (for example, as a one-wire communication interface), the example earpiece connector component 500 further reduces the required number of pins for data communications (for example, an UART interface requires at least two pins).

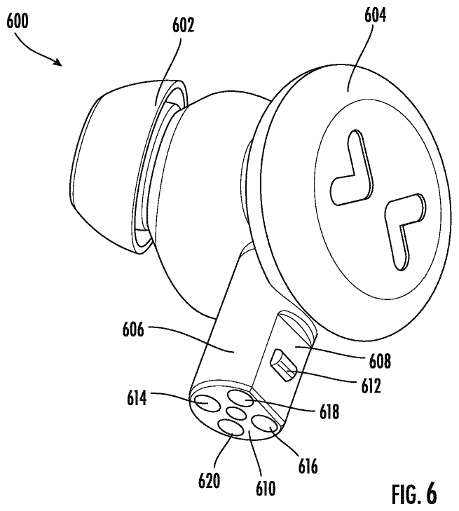

Referring now to FIG. 6, an example view of an example earpiece device in accordance with some embodiments of the present disclosure is provided.

In the example shown in FIG. 6, the example earpiece device 600 is in the form of an earbud. For example, the example earpiece device 600 comprises an earpiece interface component 602, an earpiece head component 604, and a respiratory protective device connector component 606. In some embodiments, the earpiece head component 604 is connected to both the earpiece interface component 602 and the respiratory protective device connector component 606.

In some embodiments, the earpiece interface component 602 comprises soft, flexible materials (such as silicon) and is shaped based on the contours of the car canal, so that the earpiece interface component 602 can be inserted into a user's car canal.

In some embodiments, the earpiece head component 604 provides housing for various electronic components, such as, but not limited to, one or more earpiece sound sensor components, earpiece power source component, earpiece data communication component, earpiece controller component, and/or the like.

In some embodiments, each of the one or more earpiece sound sensor components comprises a microphone. In some embodiments, the earpiece sound sensor component comprises one or more additional or alternative sound sensors that convert sound waves into electrical signals (for example, acoustic sensors, noise sensors, and/or the like).

Additionally, or alternatively, the earpiece power source component may be in the form of, such as but not limited to, one or more rechargeable batteries.

Additionally, or alternatively, the earpiece data communication component comprises hardware or a combination of hardware and software that receives and/or transmits data from/to a network, any other device, circuitry, module, and/or the like. As an example, the earpiece data communication component may be in the form of a Bluetooth® chip that comprises a radio frequency (RF) transceiver for sending and receiving communications in the 2.4 GHz industrial, scientific, and medical (ISM) radio frequency band. Additionally, or alternatively, the earpiece data communication component may be in other forms.

Additionally, or alternatively, the earpiece controller component comprises at least a processor and at least a memory, similar to the main controller component of the respiratory protective device described above in connection with at least FIG. 3.

In some embodiments, the respiratory protective device connector component 606 may be in the form of a plug that is shaped to engage with at least a portion of an earpiece receptacle of an earpiece connector component (for example, the earpiece receptacle 505 of the earpiece connector component 500 as described above).

In the example shown in FIG. 6, the respiratory protective device connector component 606 defines a plug outer side surface 608 and a plug bottom surface 610.

In some embodiments, the plug outer side surface 608 comprises a locking protrusion portion 612 that protrudes from the surrounding area. In some embodiments, when the respiratory protective device connector component 606 of the earpiece device 600 is inserted into an earpiece receptacle of an earpiece connector component, the locking protrusion portion 612 engages with a locking depression portion on the earpiece receptacle, such that the earpiece device 600 can be connected to the earpiece connector component. In some embodiments, by releasing the locking protrusion portion 612 from the locking depression portion, the earpiece device 600 can be disconnected from the earpiece connector component. As such, the connection between the earpiece device 600 and the earpiece connector component is detachable.

In some embodiments, the example earpiece device 600 comprises at least one power connector contact and at least one data connector contact that are disposed on the plug bottom surface 610 of the respiratory protective device connector component 606.

In some embodiments, when the example earpiece device 600 is connected to an earpiece connector component of a respiratory protective device, the at least one power connector contact is electronically coupled to the at least one power charging pin of the earpiece connector component. As such, electrical energy (e.g., electric current) is transferred from the respiratory protective device to the earpiece device through the connection between the at least one power connector contact and the at least one power charging pin.

In the example shown in FIG. 6, the example earpiece device 600 comprises a power connector contact 614 and a power connector contact 616. In such an example, one of the power connector contacts (for example, the power connector contact 614) transfers electrical energy from the respiratory protective device, and the other one of the power connector contacts (for example, the power connector contact 616) provides ground signals.

In some embodiments, when the example earpiece device 600 is connected to an earpiece connector component of a respiratory protective device, the at least one data connector contact is electronically coupled to the at least one data charging pin of the earpiece connector component. As such, data communication signals can be transferred between the respiratory protective device and the earpiece device through the connection between the at least one data connector contact and the at least one data transfer pin.

In the example shown in FIG. 6, the example earpiece device 600 comprises a data connector contact 618 and a data connector contact 620. In such an example, one of the data connector contacts (for example, the data connector contact 618) is electronically coupled to and receives data communication signals from the respiratory protective device based on the serial communication protocol, and the other one of the data connector contacts (for example, the data connector contact 620) is electronically coupled to the device sound sensor component of the respiratory protective device and receives sound signals.

In some embodiments, the power charging pins and the data transfer pins of the earpiece connector component comprise magnetic materials, and the power connector contacts and the data connector contacts of the earpiece device comprise metal materials. As such, the power connector contacts and the data connector contacts of the earpiece device can be aligned with the power charging pins and the data transfer pins of the earpiece connector component when the earpiece device is connected to the earpiece connector component.

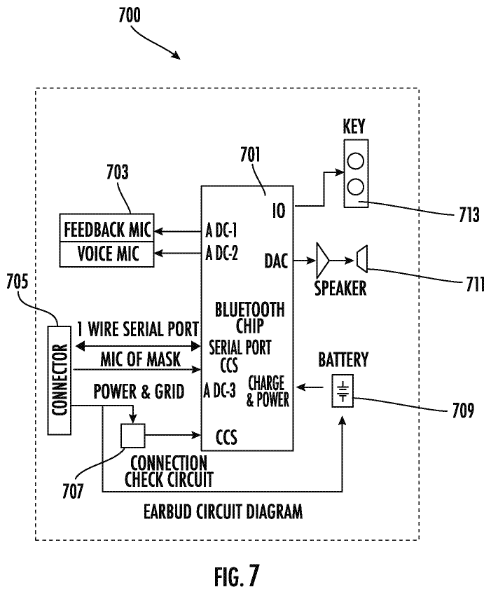

Referring now to FIG. 7, an example circuit diagram illustrating example data communications between example components of an example earpiece device 700 in accordance with some example embodiments is provided.

In the example shown in FIG. 7, the example earpiece device 700 comprises an earpiece data communication component 701.

Similar to the device data communication component described above, the earpiece data communication component 701 comprises hardware or a combination of hardware and software that receives and/or transmits data from/to a network, any other device, circuitry, module, and/or the like. As an example, the earpiece data communication component 701 may be in the form of a Bluetooth® chip that comprises a radio frequency (RF) transceiver for sending and receiving communications in the 2.4 GHz industrial, scientific, and medical (ISM) radio frequency band. Additionally, or alternatively, the earpiece data communication component 701 may be in other forms.

In some embodiments, the earpiece data communication component 701 is electronically coupled to one or more other electronic components. In the example shown in FIG. 7, the earpiece data communication component 701 is electronically coupled to components such as, but not limited to, one or more earpiece sound sensor components 703, a respiratory protective device connector component 705, a connection check circuit 707, an earpiece power source component 709, a speaker component 711, and one or more key components 713.

In some embodiments, the one or more earpiece sound sensor components 703 comprises a feedback sound sensor and a voice sound sensor. In such examples, the voice sound sensor generates sound signals based on detecting a user's voice, and the feedback sound sensor generates sound signals based on detecting feedback sound of the user's voice.

While the description above provides an example earpiece device comprising two earpiece sound sensor components, it is noted that the scope of the present disclosure is not limited to the description above. In some examples, an example earpiece device may comprise less than two or more than two earpiece sound sensor components.

In some embodiments, the one or more earpiece sound sensor components 703 can transmit sound signals to the earpiece data communication component 701. In some embodiments, the earpiece data communication component 701 may transmit control signals (such as, but not limited to, sound sensor activation signals) to the one or more earpiece sound sensor components 703.

In some embodiments, the respiratory protective device connector component 705 comprises at least one power connector contact and at least one data connector contact (similar to the power connector contacts and the data connector contacts described above in connection with FIG. 6).

In some embodiments, the respiratory protective device connector component 705 provides a serial communication port based on serial communication protocols for exchanging data communication signals between the earpiece device 700 and one or more respiratory protective devices. For example, sound signals detected by the earpiece sound sensor components 703 can be transmitted through the serial communication port of the respiratory protective device connector component 705.

In some embodiments, the connection check circuit 707 is electronically coupled to both the respiratory protective device connector component 705 and the earpiece data communication component 701. In some embodiments, the connection check circuit 707 determines whether the example earpiece device 700 is electronically coupled to a respiratory protective device based on, for example, but not limited to, whether electric currents are received from the respiratory protective device connector component 705.

As described above, when the earpiece device is connected to the respiratory protective device, the respiratory protective device connector component 705 of the earpiece device 700 is inserted into the earpiece receptacle of the earpiece connector component as described above. In such an example, at least one power connector contact of the respiratory protective device connector component 705 is electronically coupled to the at least one power charging pin of the earpiece connector component. As such, electrical energy (e.g., electric current) is transferred from the respiratory protective device to the earpiece device through the respiratory protective device connector component 705. In some embodiments, the connection check circuit 707 comprises an electric current detection circuit that can detect whether a power signal (for example, an electric current) is received from the respiratory protective device connector component 705.

Similar to the device power source component described above, the earpiece power source component 709 provides a source of electrical energy. In some embodiments, the earpiece power source component 709 may be in the form of, such as but not limited to, one or more rechargeable batteries, one or more supercapacitors, one or more ultracapacitors, and/or the like.

In some embodiments, the earpiece power source component 709 is electronically coupled to the earpiece data communication component 701 and provides electrical energy to the earpiece data communication component 701.

In some embodiments, the earpiece power source component 709 is electronically coupled to the respiratory protective device connector component 705 (for example, to the at least one power connector contact of the respiratory protective device connector component as described above). In some embodiments, the earpiece power source component 709 receives electrical energy for charging through the respiratory protective device connector component 705, details of which are described herein.

In some embodiments, the speaker component 711 comprises one or more speakers. In some embodiments, the earpiece data communication component 701 may transmit control signals (such as, but not limited to, speaker activation signals) to the speaker component 711.

In some embodiments, the earpiece data communication component 701 is in electronic communications with one or more key components 713. In some embodiments, the one or more key components 713 comprise one or more buttons that are disposed on the outer surface of the earpiece device. For example, when a user presses a button on the key components 713, the key components 713 may transmit a corresponding signal to the earpiece data communication component 701, triggering one or more operations associated with the earpiece device 700 (such as, but not limited to, adjusting the volume, triggering noise canceling mode, and/or the like).

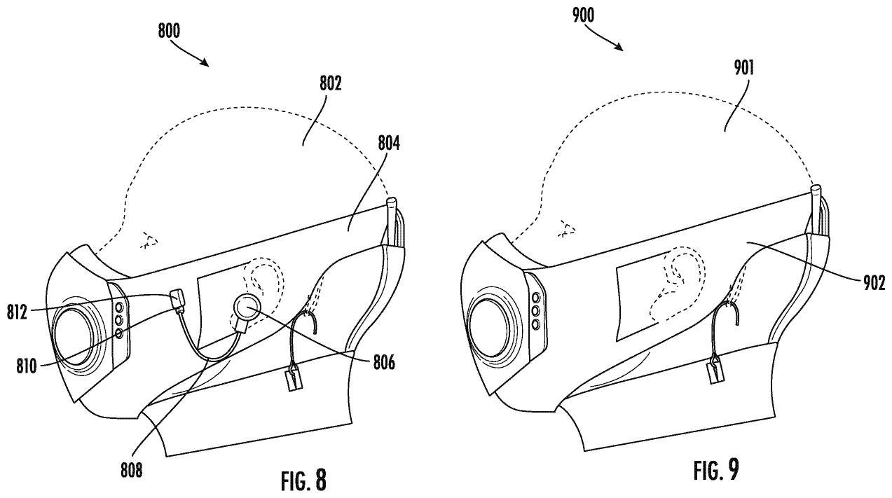

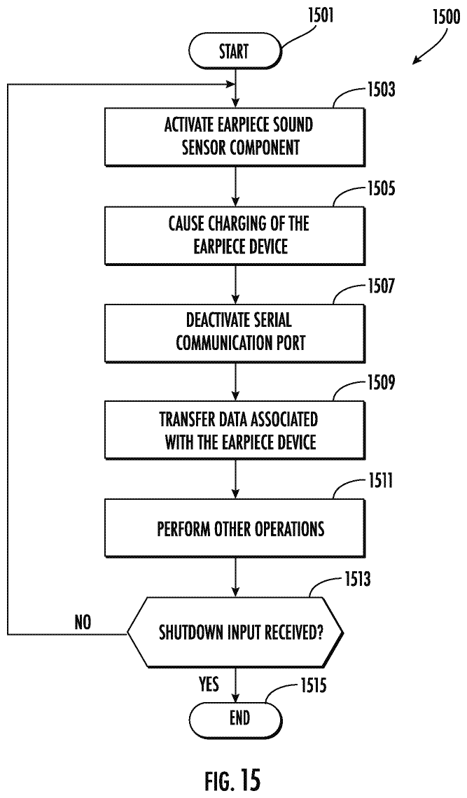

Referring now to FIG. 8 and FIG. 15, example diagrams illustrating example methods in accordance with various embodiments of the present disclosure are illustrated.

It is noted that each block of the flowchart, and combinations of blocks in the flowchart, may be implemented by various means such as hardware, firmware, circuitry and/or other devices associated with execution of software including one or more computer program instructions. For example, one or more of the steps/operations described in FIG. 8 and/or FIG. 15 may be embodied by computer program instructions, which may be stored by a non-transitory memory of an apparatus employing an embodiment of the present disclosure and executed by a processing circuitry in the apparatus. For example, these computer program instructions may direct an example main controller component described herein to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

Referring now to FIG. 8, an example illustration 800 is provided. In the example illustration 800, an example user 802 wears an example respiratory protective device 804 and a pair of earpiece devices (including the example earpiece device 806) in accordance with some embodiments of the present disclosure.

In the example shown in FIG. 8, the example earpiece device 806 is detachably connected to the example respiratory protective device 804 through the example earpiece connector component 808, similar to the various examples described above.

For example, the earpiece connector component 808 comprises a connector plug 810 that is detachably connected to a connector receptacle 812 disposed on an outer surface of the respiratory protective device 804. As such, the earpiece connector component 808 is detachably connected to the respiratory protective device 804. In some embodiments, the connector receptacle 812 comprises a rope winder structure that can retract the earpiece connector component 808.

Additionally, or alternatively, the example earpiece device 806 is detachably connected to the earpiece connector component 808 through, for example but not limited to, engaging the locking depression portion of the earpiece connector component 808 with the locking protrusion portion of the example earpiece device 806, similar to the examples described above.

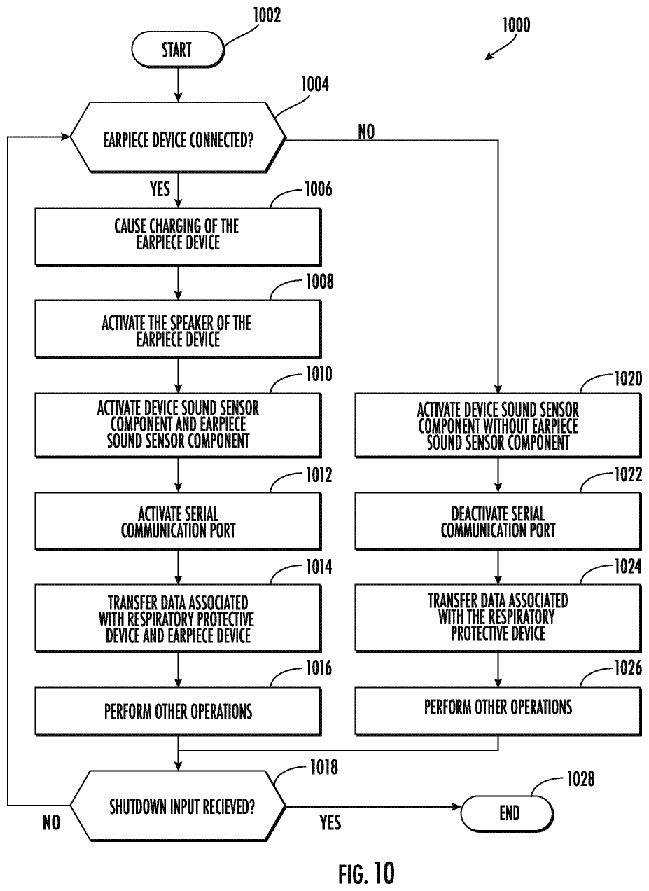

Referring now to FIG. 9, an example illustration 900 is provided. In the example illustration 900, an example user 901 wears an example respiratory protective device 902 without wearing any example earpiece devices.

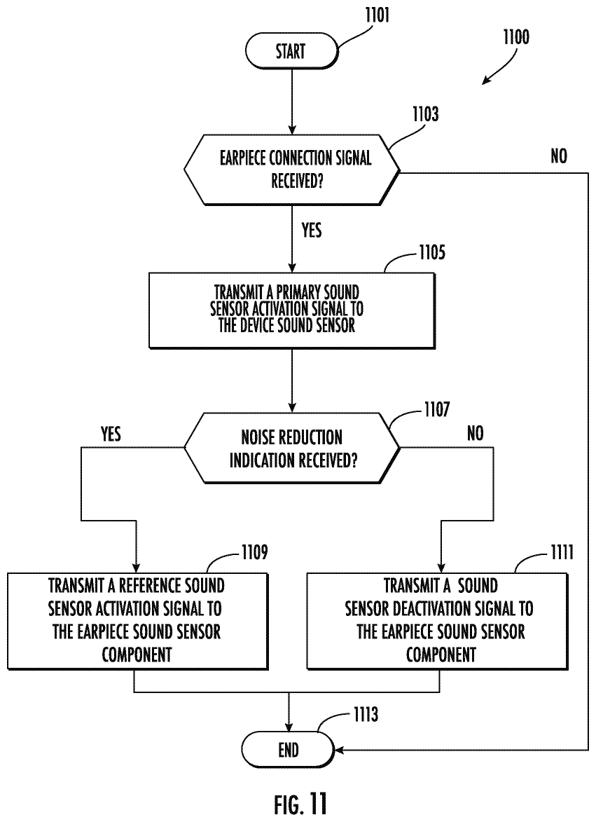

Referring now to FIG. 10, an example method 1000 of operating an example respiratory protective device in accordance with some example embodiments described herein is illustrated.

In FIG. 10, the example method 1000 starts at step/operation 1002. In some embodiments, subsequent to and/or in response to step/operation 1002, the example method 1000 proceeds to step/operation 1004. At step/operation 1004, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may determine whether an earpiece device is connected to the respiratory protective device.

In some embodiments, the main controller component of the respiratory protective device may determine whether the earpiece device is connected to the respiratory protective device based on whether an earpiece connection signal is received by the respiratory protective device.

For example, the main controller component of the respiratory protective device may determine whether the earpiece connector component provides an earpiece connection signal. As described above, when the earpiece device is connected to the respiratory protective device, the earpiece connector component creates a close circuit that electronically couples the respiratory protective device and the earpiece device. In some embodiments, upon receiving a signal from the earpiece device, the earpiece connector component provides an earpiece connection signal to the main controller component, and the earpiece connection signal indicates that the earpiece device is connected to the respiratory protective device.

While the description above provides an example of determining whether the earpiece device is connected to the respiratory protective device, it is noted that the scope of the present disclosure is not limited to the description above. For example, when the earpiece device is connected to the respiratory protective device, the electric current in the earpiece connector component changes. Based on the change in the electric current, the main controller component can determine that the earpiece connector component provides an earpiece connection signal.

Additionally, or alternatively, the earpiece controller component of the earpiece device may determine whether the earpiece device is connected to the respiratory protective device through the connection check circuit.

As described above in connection with at least FIG. 7, the earpiece device comprises a connection check circuit. In some embodiments, the connection check circuit determines whether electric currents are received from the respiratory protective device connector component through the respiratory protective device connector of the earpiece device. In some embodiments, in response to determining that a power signal is received from the respiratory protective device, the connection check circuit provides an earpiece connection signal to the earpiece controller component of the earpiece device and/or the main controller component of the respiratory protective device.

Referring back to FIG. 10, if, at step/operation 1004, the controller determines that the earpiece device is connected to the respiratory protective device, the example method 1000 proceeds to step/operation 1006. At step/operation 1006, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may cause charging of the earpiece device.

For example, when an example earpiece device is connected to an earpiece connector component of a respiratory protective device, the at least one power connector contact of the example earpiece device is electronically coupled to the at least one power charging pin of the earpiece connector component. Because the earpiece connector component is electronically coupled to the device power source component, the earpiece connector component creates a close circuit that electronically couples the device power source component to the earpiece device.

In some embodiments, upon receiving the earpiece connection signal, the main controller component of the respiratory protective device transmits a power charging signal to the device power source component to cause the device power source component to charge the earpiece power source component of the earpiece device. As such, electrical energy (e.g., electric current) is transferred from the respiratory protective device to the earpiece device through the earpiece connector component.

Referring back to FIG. 10, subsequent to and/or in response to step/operation 1006, the example method 1000 proceeds to step/operation 1008. At step/operation 1008, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may activate the speaker of the earpiece device.

For example, when the earpiece device is connected to the respiratory protective device, the main controller component of the respiratory protective device transmits a speaker activation signal to the speaker component of the earpiece device, so that the speaker component can provide audio outputs (for example, playing music). In other words, after the earpiece device is connected to the respiratory protective device, the earpiece device can continue performing its audio functions (such as playing music) without interruption.

Referring back to FIG. 10, subsequent to and/or in response to step/operation 1008, the example method 1000 proceeds to step/operation 1010. At step/operation 1010, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may activate device sound sensor component (and earpiece sound sensor component).

As described above, the respiratory protective device may comprise a device sound sensor component, and the earpiece device may comprise an earpiece sound sensor component. In some embodiments, when the earpiece device is connected to the respiratory protective device, the device sound sensor component is located closer to a user's mouth than the earpiece sound sensor component. As such, the main controller component of the respiratory protective device may transmit a primary sound sensor activation signal to the device sound sensor component, so that the device sound sensor component can function as the main microphone to provide better quality of voice detection. In some embodiments, the main controller component of the respiratory protective device may transmit a reference sound sensor activation signal or a sound sensor deactivation signal to the earpiece sound sensor component, so that the earpiece sound sensor component can function as a reference microphone for active noise cancellation or can cease to operate to conserve power.

As an example, when the user wears both the respiratory protective device and the earpiece device to make a telephone call, the device sound sensor component of the respiratory protective device can function as the main microphone for voice detection, and the earpiece sound sensor component of the earpiece device can function as a reference microphone for active noise cancellation (or may be deactivated).

Referring back to FIG. 10, subsequent to and/or in response to step/operation 1010, the example method 1000 proceeds to step/operation 1012. At step/operation 1012, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may activate the serial communication port.

As described above, the earpiece connector component and the respiratory protective device connector component provide a serial communication port based on serial communication protocols for exchanging data communication signals between one or more earpiece devices and the respiratory protective device. In some embodiments, in response determining that the earpiece device is connected to the respiratory protective device at step/operation 1004, the main controller component of the respiratory protective device opens the serial communication port by transmitting activation signals to the earpiece connector component and the respiratory protective device connector component, so as to enable data communications between the respiratory protective device and the earpiece device.

Referring back to FIG. 10, subsequent to and/or in response to step/operation 1012, the example method 1000 proceeds to step/operation 1014. At step/operation 1014, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may transfer data associated with respiratory protective device and earpiece device.

In some embodiments, subsequent to activating the serial communication port at step/operation 1012, the main controller component of the respiratory protective device causes data and/or information associated with the respiratory protective device and the earpiece device to be transferred to a computing device (for example, to an application or “app” running on the computing device).

For example, the respiratory protective device may comprise various sensor components that are in data communications with the main controller component. In some embodiments, the main controller component may provide various data and/or information detected by the sensor components (such as, but not limited to, air pressure indications, humidity indications, air quality indications, and/or the like) through the device data communication component of the respiratory protective device and/or through the earpiece data communication component of the earpiece device (via the serial communication port).

Additionally, or alternatively, the main controller component may receive various data and/or information associated with the earpiece device (such as, but not limited to, the battery status, volume information, and/or the like) via the serial communication port, and can transmit data and/or information associated with the earpiece device through the device data communication component of the respiratory protective device and/or through the earpiece data communication component of the earpiece device (via the serial communication port).

Referring back to FIG. 10, subsequent to and/or in response to step/operation 1014, the example method 1000 proceeds to step/operation 1016. At step/operation 1016, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may perform other operations.

For example, the main controller component of an example respiratory protective device may perform other operations in addition to the examples described above (such as, but not limited to, communicating with apps). Additionally, or alternatively, the earpiece controller component of the earpiece device may perform other operations such as, but not limited to, causing the speaker component to provide audio output (e.g. playing music).

Referring back to FIG. 10, subsequent to and/or in response to step/operation 1016, the example method 1000 proceeds to step/operation 1018. At step/operation 1018, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may determine whether a shutdown input has been received.

In some embodiments, the shutdown input indicates a user request to disconnect the data communications between the earpiece device and the respiratory protective device. For example, a user may provide a shutdown input by pressing one or more buttons of the key component on the respiratory protective device and/or on the earpiece device.

If, at step/operation 1018, the controller determines that the shutdown input has not been received, the example method 1000 returns to step/operation 1004.

If, at step/operation 1018, the controller determines that the shutdown input has been received, the example method 1000 proceeds to step/operation 1028 and ends.

As illustrated in the example steps/operations above, various embodiments of the present disclosure provide earpiece devices that are not only detachable from the respiratory protective device, but also overridable. For example, various functions associated with the earpiece device can be overridden when the earpiece device is connected to the respiratory protective device. As such, the combination of the respiratory protective device and the earpiece device can provide features as a whole product.

In some embodiments, when the earpiece device is connected to the respiratory protective device and provides audio outputs (for example, playing music), the earpiece device may receive audio files via the device data communication component of the respiratory protective device instead of the earpiece data communication component of the earpiece device to converse energy.

In some embodiments, when the earpiece device is connected to the respiratory protective device, support for data communications with other computing devices is provided via device data communication component of the respiratory protective device instead of the earpiece data communication component of the earpiece device to converse energy.

In some embodiments, when the earpiece device is connected to the respiratory protective device, the device sound sensor component of the respiratory protective device (instead of the earpiece sound sensor component of the earpiece device) provides voice capture during a telephone call, and the device data communication component of the respiratory protective device (instead of the earpiece data communication component of the earpiece device) transmits the voice data to other computer devices.

In some embodiments, when the earpiece device is connected to the respiratory protective device, active noise cancellation features can be achieved based on implementing one of the sound sensor components as the primary microphone and one of the sound sensor components as the reference microphone. For example, the earpiece sound sensor component can be activated as the primary microphone for voice capture, and the device sound sensor component can be activated as the reference microphone for noise cancellation. Additionally, or alternatively, the device sound sensor component can be activated as the primary microphone for voice capture, and the earpiece sound sensor component can be activated as the reference microphone for noise cancellation. In some embodiments, sound data captured by the earpiece sound sensor component and the device sound sensor component are transmitted through the device data communication component of the respiratory protective device.

In some embodiments, when the earpiece device is connected to the respiratory protective device, data and/or information detected by the sensor components of the respiratory protective device (such as, but not limited to, air pressure indications, humidity indications, air quality indications, and/or the like), along with data and/or information associated with the earpiece device (such as, but not limited to, the battery status, volume information, and/or the like), can be transmitted to computing devices via the earpiece data communication component of the earpiece device alone or via the device data communication component of the respiratory protective device alone.

In some embodiments, when the earpiece device is connected to the respiratory protective device, the device power source component of the respiratory protective device can charge both the respiratory protective device and the earpiece device.

Referring back to FIG. 10, if, at step/operation 1004, the controller determines that the earpiece device is not connected, the example method 1000 proceeds to step/operation 1020. At step/operation 1020, a controller (such as, but not limited to, a main controller component of an example respiratory protective device described above in connection with at least FIG. 2A to FIG. 4) may activate device sound sensor component without earpiece sound sensor component.

In some embodiments, when the earpiece device is not connected to the respiratory protective device, the main controller component can only activate the device sound sensor component because the earpiece sound sensor component is not connected to the main controller component.

Referring back to FIG. 10, subsequent to and/or in response to step/operation 1020, the example method 1000 proceeds to step/operation 1022. At step/operation 1022, a controller (such as, but not limited to, a main controller component of an example respiratory protective device described above in connection with at least FIG. 2A to FIG. 4) may deactivate the serial communication port.

As described above, the earpiece connector component provides a serial communication port based on serial communication protocols for exchanging data communication signals between one or more earpiece devices and the respiratory protective device. In some embodiments, in response to determining that no earpiece device is connected to the respiratory protective device, the main controller component of the respiratory protective device closes the serial communication port by transmitting a deactivation signal to the earpiece connector component, so as to conserve energy.

Referring back to FIG. 10, subsequent to and/or in response to step/operation 1022, the example method 1000 proceeds to step/operation 1024. At step/operation 1024, a controller (such as, but not limited to, a main controller component of an example respiratory protective device described above in connection with at least FIG. 2A to FIG. 4) may transfer data associated with the respiratory protective device.

In some embodiments, the main controller component of the respiratory protective device causes data and/or information associated with the respiratory protective device to be transferred to a computing device (for example, to an application or “app” running on the computing device).

For example, the respiratory protective device may comprise various sensor components that are in data communications with the main controller component. In some embodiments, the main controller component may provide various data and/or information detected by the sensor components (such as, but not limited to, air pressure indications, humidity indications, air quality indications, and/or the like) through the device data communication component of the respiratory protective device. Because the earpiece device is not connected to the respiratory protective device, the main controller component does not transmit data and/or information associated with the earpiece device (such as, but not limited to, the battery status, volume information, and/or the like).

Referring back to FIG. 10, subsequent to and/or in response to step/operation 1024, the example method 1000 proceeds to step/operation 1026. At step/operation 1026, a controller (such as, but not limited to, a main controller component of an example respiratory protective device described above in connection with at least FIG. 2A to FIG. 4) may perform other operations.

For example, the main controller component of an example respiratory protective device may perform other operations in addition to the examples described above (such as, but not limited to, communicating with apps).

Referring back to FIG. 10, at step/operation 1026, the example method 1000 proceeds to step/operation 1018. At step/operation 1018, a controller (such as, but not limited to, a main controller component of an example respiratory protective device described above in connection with at least FIG. 2A to FIG. 4) may determine whether a shutdown input has been received.

In some embodiments, the shutdown input indicates a user request to turn off the respiratory protective device. For example, a user may provide a shutdown input by pressing one or more buttons of the key component on the respiratory protective device.

If, at step/operation 1018, the controller determines that the shutdown input has not been received, the example method 1000 returns to step/operation 1004.

If, at step/operation 1018, the controller determines that the shutdown input has been received, the example method 1000 proceeds to step/operation 1028 and ends.

As illustrated in the example steps/operations above, when a respiratory protective device is not connected to any earpiece devices, the respiratory protective device can provide various features as a smart respiratory protective device with active ventilation, LED rings, and/or the like.

In some embodiments, when the respiratory protective device is not connected to any earpiece devices, the respiratory protective device may receive audio files via the device data communication component of the respiratory protective device, and provide audio outputs (for example, playing music).

In some embodiments, when the respiratory protective device is not connected to any earpiece devices, support for data communications with other computing devices is provided via device data communication component of the respiratory protective device.

In some embodiments, when the respiratory protective device is not connected to any earpiece devices, data and/or information detected by the sensor components of the respiratory protective device (such as, but not limited to, air pressure indications, humidity indications, air quality indications, and/or the like) can be transmitted to computing devices via the device data communication component of the respiratory protective device.

In some embodiments, when the respiratory protective device is not connected to any earpiece devices, the device power source component of the respiratory protective device can charge the respiratory protective device.

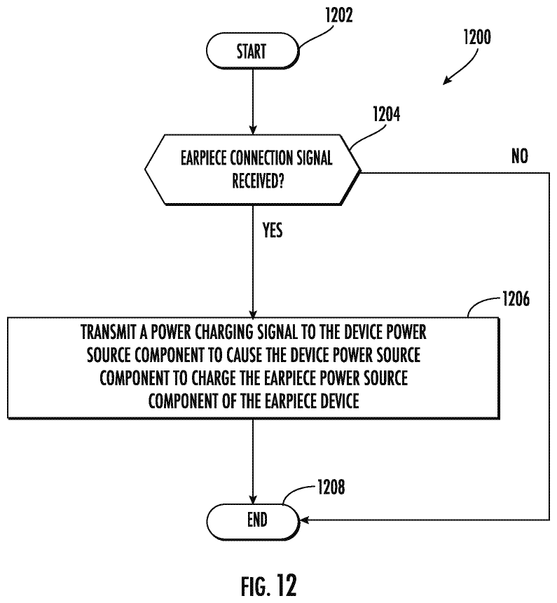

Referring now to FIG. 11, an example method 1100 of operating an example respiratory protective device in accordance with some example embodiments described herein is illustrated. In particular, the example method 1100 provides an example workflow when an earpiece device is connected to a respiratory protective device (as shown in FIG. 8).

In FIG. 11, the example method 1100 starts at step/operation 1101. In some embodiments, subsequent to and/or in response to step/operation 1101, the example method 1100 proceeds to step/operation 1103. At step/operation 1103, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may determine whether an earpiece connection signal is received.

In some embodiments, the controller may determine whether an earpiece connection signal is received similar to those described above in connection with at least step/operation 1004 of FIG. 10.

If, at step/operation 1103, the controller determines that the earpiece connection signal is not received, the example method 1100 proceeds to step/operation 1111 and ends.

If, at step/operation 1103, the controller determines that the earpiece connection signal is received, the example method 1100 proceeds to step/operation 1105. At step/operation 1105, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may transmit a primary sound sensor activation signal to the device sound sensor.

As described above, the respiratory protective device comprises a device sound sensor component and the earpiece device comprises an earpiece sound sensor component. In some embodiments, when the earpiece device is connected to the respiratory protective device, the main controller component determines one of the sound sensor components as the primary sound sensor. In such examples, sound signals detected by the primary sound sensor are used as the primary source for capturing voices from the users.

In the example shown in FIG. 11, the controller determines that the device sound sensor component disposed on the respiratory protective device is the primary sound sensor because the device sound sensor component is located closer to the user's mouth as compared to the earpiece sound sensor component. In some embodiments, the controller transmits a primary sound sensor activation signal to the device sound sensor component. In some embodiments, the primary sound sensor activation signal is a control signal that activates a sound sensor component as a primary sound sensor. In some embodiments, subsequent to receiving the primary sound sensor activation signal, the device sound sensor component provides sound signals to the device data communication component or the earpiece data communication component as primary sources.

Referring back to FIG. 11, subsequent to and/or in response to step/operation 1105, the example method 1100 proceeds to step/operation 1107. At step/operation 1107, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may determine whether a noise reduction indication is received.

In some embodiments, the noise reduction indication indicates a user request to reduce the background noise in the audio output from the earpiece device. For example, when a user presses one or more buttons of the key component on the respiratory protective device, the key component may transmit a noise reduction indication to the main controller component of the respiratory protective device. Additionally, or alternatively, when a user presses one or more buttons of the key component on the earpiece device, the key component may transmit a noise reduction indication to the main controller component of the respiratory protective device (for example, through the serial communication port described above).

If at step/operation 1107, the controller determines that the noise reduction indication is received, the example method 1100 proceeds to step/operation 1109. At step/operation 1109, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may transmit a reference sound sensor activation signal to the earpiece sound sensor component.

In some embodiments, when a noise reduction indication is received, the controller identifies one or more sound sensors as one or more reference sound sensors. In such examples, sound signals detected by the reference sound sensors are used as reference sources to determine noises in the background for reduction.

In the example shown in FIG. 11, the controller determines that the earpiece sound sensor component of the earpiece device is the reference sound sensor. In some embodiments, the controller transmits a reference sound sensor activation signal to the earpiece sound sensor component of the earpiece device. In some embodiments, the reference sound sensor activation signal is a control signal that activates a sound sensor component as a reference sound sensor. In some embodiments, subsequent to receiving the reference sound sensor activation signal, the earpiece sound sensor component provides sound signals to the earpiece data communication component or the device data communication component as reference sources.

If at step/operation 1107, the controller determines that the noise reduction indication is not received, the example method 1100 proceeds to step/operation 1111. At step/operation 1111, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may transmit a sound sensor deactivation signal to the earpiece sound sensor component.

In some embodiments, based on determining that the noise reduction indication is not received, the controller determines that there is no need for sound signals from the earpiece sound sensor component of the earpiece device (because the device sound sensor component already provides sound signals). In some embodiments, the controller transmits a sound sensor deactivation signal to the earpiece sound sensor component. In some embodiments, in response to receiving the sound sensor deactivation signal, the earpiece device turns off the earpiece sound sensor component to conserve energy.

Referring back to FIG. 11, subsequent to and/or in response to step/operation 1109 and step/operation 1111, the example method 1100 proceeds to step/operation 1113 and ends.

Referring now to FIG. 12, an example method 1200 of operating an example respiratory protective device in accordance with some example embodiments described herein is illustrated. In particular, the example method 1200 provides an example workflow when an earpiece device is connected to a respiratory protective device (as shown in FIG. 8).

In FIG. 12, the example method 1200 starts at step/operation 1202. In some embodiments, subsequent to and/or in response to step/operation 1202, the example method 1200 proceeds to step/operation 1204. At step/operation 1204, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may determine whether an earpiece connection signal is received.

In some embodiments, the controller may determine whether an earpiece connection signal is received similar to those described above in connection with at least step/operation 1004 of FIG. 10.

If, at step/operation 1204, the controller determines that the earpiece connection signal is not received, the example method 1200 proceeds to step/operation 1208 and ends.

If, at step/operation 1204, the controller determines that the earpiece connection signal is received, the example method 1200 proceeds to step/operation 1206. At step/operation 1206, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may transmit a power charging signal to the device power source component to cause the device power source component to charge the earpiece power source component of the earpiece device.

As illustrated above in connection with at least FIG. 3 to FIG. 5B, the earpiece connector component comprises at least one power charging pin that is electronically coupled to the device power source component of the respiratory protective device. As illustrated above in connection with at least FIG. 6 to FIG. 7, the example earpiece device comprises at least one power connector contact that is electronically coupled to the earpiece power source component of the earpiece device. In some embodiments, when the earpiece device is connected to the respiratory protective device, the at least one power charging pin is in contact with the at least one power connector contact, creating a close circuit that electronically couples the device power source component of the respiratory protective device to the earpiece power source component of the earpiece device.

In some embodiments, in response to the earpiece connection signal, the main controller component of the respiratory protective device transmits a power charging signal to the device power source component. In some embodiments, the power charging signal is a control signal that causes the device power source component to charge the earpiece power source component of the earpiece device. As such, energy from the earpiece power source component can be conserved. In some embodiments, the power charging signal further causes the device power source component to provide power to other electronic components of the earpiece device (such as, but not limited to, the earpiece data communication component).

Referring back to FIG. 12, subsequent to and/or in response to step/operation 1206, the example method 1200 proceeds to step/operation 1208 and ends.

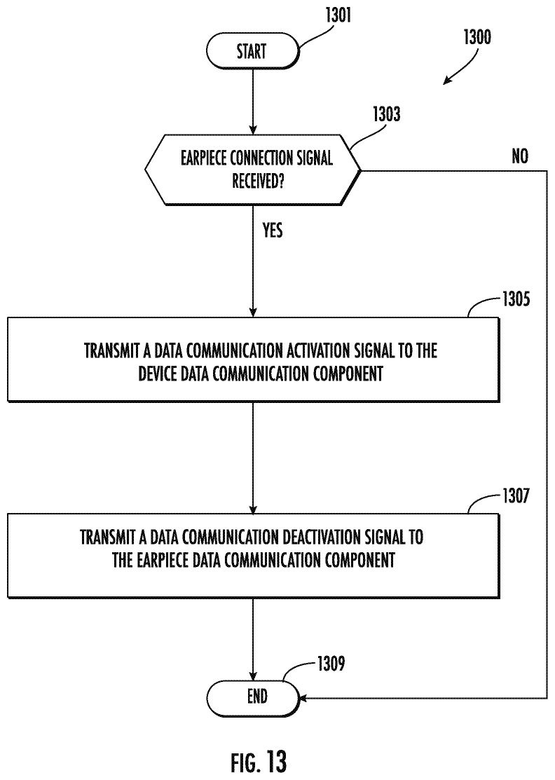

Referring now to FIG. 13, an example method 1300 of operating an example respiratory protective device in accordance with some example embodiments described herein is illustrated. In particular, the example method 1300 provides an example workflow when an earpiece device is connected to a respiratory protective device (as shown in FIG. 8).

In FIG. 13, the example method 1300 starts at step/operation 1301. In some embodiments, subsequent to and/or in response to step/operation 1301, the example method 1300 proceeds to step/operation 1303. At step/operation 1303, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may determine whether an earpiece connection signal is received.

In some embodiments, the controller may determine whether an earpiece connection signal is received similar to those described above in connection with at least step/operation 1004 of FIG. 10.

If, at step/operation 1303, the controller determines that the earpiece connection signal is not received, the example method 1300 proceeds to step/operation 1309 and ends.

If, at step/operation 1303, the controller determines that the earpiece connection signal is received, the example method 1300 proceeds to step/operation 1305. At step/operation 1305, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may transmit a data communication activation signal to the device data communication component.

In some embodiments, the data communication activation signal is a control signal to activate (e.g. turn on) a data communication component. As described above, the respiratory protective device comprises a device data communication component and the earpiece device comprises an earpiece data communication component. In some embodiments, when the earpiece device is connected to the respiratory protective device, there is a redundancy of data communication components, which can cause unnecessary power usage.

In the example shown in FIG. 13, the main controller component determines to use the device data communication component as the only data communication component. For example, the main controller component may transmit various data and/or information detected by the sensor components (such as, but not limited to, air pressure indications, humidity indications, air quality indications, and/or the like) through the device data communication component. In addition, the main controller component may receive various data and/or information associated with the earpiece device (such as, but not limited to, the battery status, volume information, and/or the like) via the serial communication port as described above, and transmit data and/or information associated with the earpiece device associated with the earpiece device through the device data communication component.

In some embodiments, subsequent to and/or in response to step/operation 1305, the example method 1300 proceeds to step/operation 1307. At step/operation 1307, a controller (such as, but not limited to, a main controller component of an example respiratory protective device described above in connection with at least FIG. 2A to FIG. 4, and/or an earpiece controller component of an example earpiece device described above in connection with at least FIG. 6 and FIG. 7) may transmit a data communication deactivation signal to the earpiece data communication component.

In some embodiments, the data communication deactivation signal is a control signal to deactivate (e.g. turn off) a data communication component. In the example shown in FIG. 13, the main controller component determines to deactivate any data communication component other than the device data communication component. As such, the main controller component transmits a data communication deactivation signal to the earpiece data communication component. In response to receiving the data communication deactivation signal, the earpiece device deactivates the earpiece data communication component to conserve energy.

Referring back to FIG. 13, subsequent to and/or in response to step/operation 1307, the example method 1300 proceeds to step/operation 1309 and ends.

While the description above provides an example of activating the device data communication component and deactivating the earpiece data communication component, it is noted that the scope of the present disclosure is not limited to the description above. In some embodiments, in response to receiving the earpiece connection signal from the earpiece connector component, the controller may transmit a data communication deactivation signal to the device data communication component, and transmit a data communication activation signal to the earpiece data communication component.

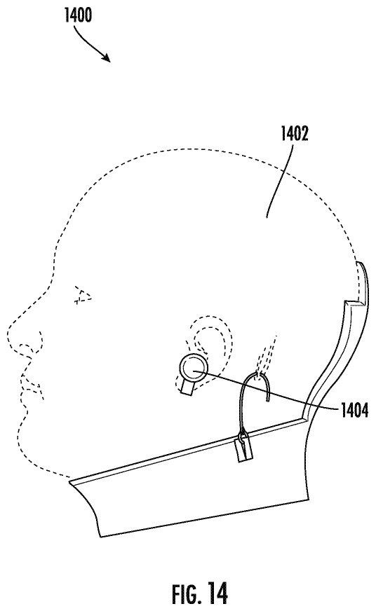

Referring now to FIG. 14, an example illustration 1400 is provided. In the example illustration 1400, an example user 1402 wears a pair of example earpiece devices (including the example earpiece device 1404) without wearing any example respiratory protective device.

Referring now to FIG. 15, an example method 1500 in accordance with some embodiments of the present disclosure is provided. In particular, the example method 1500 illustrates example workflows of an example earpiece device when the example earpiece device is not connected to any respiratory protective device (as shown in FIG. 14).

In FIG. 15, the example method 1500 starts at step/operation 1501. In some embodiments, subsequent to and/or in response to step/operation 1501, the example method 1500 proceeds to step/operation 1503. At step/operation 1503, a controller (such as, but not limited to, the earpiece controller component of an example earpiece device described above in connection with at least FIG. 6 and FIG. 7) may activate the earpiece sound sensor component.

For example, the earpiece controller component of the example earpiece device can activate the earpiece sound sensor component for voice detection during a telephone call.

Referring back to FIG. 15, subsequent to and/or in response to step/operation 1503, the example method 1500 proceeds to step/operation 1505. At step/operation 1505, a controller (such as, but not limited to, the earpiece controller component of an example earpiece device described above in connection with at least FIG. 6 and FIG. 7) may cause charging of the earpiece device.

For example, the charging of the earpiece device can be achieved through connecting the earpiece device to a power charging dock. In such an example, after the earpiece device is connected to the power charging dock, the earpiece controller component of the example earpiece device can transmit a power charging signal to the earpiece device to cause the earpiece power source component to be charged by the power charging dock.

Referring back to FIG. 15, subsequent to and/or in response to step/operation 1505, the example method 1500 proceeds to step/operation 1507. At step/operation 1507, a controller (such as, but not limited to, the earpiece controller component of an example earpiece device described above in connection with at least FIG. 6 and FIG. 7) may deactivate the serial communication port.

As described above, the respiratory protective device connector component of the earpiece device provides a serial communication port based on serial communication protocols for exchanging data communication signals between the earpiece device and one or more respiratory protective devices. In some embodiments, in response to determining that no earpiece device is connected to the earpiece device, the earpiece controller component of the earpiece device closes the serial communication port by transmitting a deactivation signal to the respiratory protective device connector component, so as to conserve energy.

Referring back to FIG. 15, subsequent to and/or in response to step/operation 1507, the example method 1500 proceeds to step/operation 1509. At step/operation 1509, a controller (such as, but not limited to, the earpiece controller component of an example earpiece device described above in connection with at least FIG. 6 and FIG. 7) may transfer data associated with the earpiece device.

In some embodiments, the earpiece controller component of the earpiece device causes data and/or information associated with the earpiece device to be transferred to a computing device (for example, to an application or “app” running on the computing device).

For example, the earpiece controller component may receive various data and/or information associated with the earpiece device (such as, but not limited to, the battery status, volume information, and/or the like), and can transmit data and/or information associated with the earpiece device through the earpiece data communication component of the earpiece device.

Referring back to FIG. 15, subsequent to and/or in response to step/operation 1509, the example method 1500 proceeds to step/operation 1511. At step/operation 1511, a controller (such as, but not limited to, the earpiece controller component of an example earpiece device described above in connection with at least FIG. 6 and FIG. 7) may perform other operations.

For example, the earpiece controller component of the earpiece device may perform other operations such as, but not limited to, causing the speaker component to provide audio output (e.g. playing music).

Referring back to FIG. 15, subsequent to and/or in response to step/operation 1511, the example method 1500 proceeds to step/operation 1513. At step/operation 1513, a controller (such as, but not limited to, the earpiece controller component of an example earpiece device described above in connection with at least FIG. 6 and FIG. 7) may determine whether a shutdown input has been received.

In some embodiments, the shutdown input indicates a user request to turn off the earpiece device. For example, a user may provide a shutdown input by pressing one or more buttons of the key component on the earpiece device.

If, at step/operation 1513, the controller determines that the shutdown input has been received, the example method 1500 proceeds to step/operation 1515 and ends.

If, at step/operation 1513, the controller determines that the shutdown input has been not received, the example method 1500 returns to step/operation 1503.

As illustrated in the example steps/operations above, when an earpiece device is not connected to any respiratory protective devices, the earpiece device can provide various features as true wireless stereo earbuds.

In some embodiments, when the earpiece device is not connected to any respiratory protective device, the earpiece device may receive audio files via the earpiece data communication component of the earpiece device.

In some embodiments, when the earpiece device is not connected to any respiratory protective device, support for data communications with other computing devices is provided via the earpiece data communication component of the earpiece device.

In some embodiments, when the earpiece device is not connected to any respiratory protective device, the earpiece sound sensor component of the earpiece device provides voice capture during a telephone call, and the earpiece data communication component of the earpiece device transmits the voice data to other computer devices.

In some embodiments, when the earpiece device is not connected to any respiratory protective device, active noise cancellation features can be achieved based on implementing one of the sound sensor components of the earpiece device as the primary microphone and one of the sound sensor components of the earpiece device as the reference microphone. In some embodiments, the earpiece data communication component of the earpiece device transmits the voice data to other computer devices.

In some embodiments, when the earpiece device is not connected to any respiratory protective device, data and/or information associated with the earpiece device (such as, but not limited to, the battery status, volume information, and/or the like) can be transmitted to computing devices via the earpiece data communication component of the earpiece device.

In some embodiments, when the earpiece device is not connected to any respiratory protective device, the earpiece power source component of the earpiece device can charge the earpiece device.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

1. A respiratory protective device comprising:
an earpiece connector component detachably connected to the respiratory protective device; and
a main controller component electronically coupled to the earpiece connector component, wherein the main controller component is configured to:
in response to receiving an earpiece connection signal associated with an earpiece device from the earpiece connector component:
transmit a primary sound sensor activation signal to a device sound sensor component disposed on the respiratory protective device; and
transmit at least one of a reference sound sensor activation signal or a sound sensor deactivation signal to an earpiece sound sensor component of the earpiece device.

2. The respiratory protective device of claim 1, wherein the earpiece connector component comprises a connector plug that is detachably connected to a connector receptacle disposed on an outer surface of the respiratory protective device.

3. The respiratory protective device of claim 2, wherein the respiratory protective device comprises a device power source component and a device data communication component, wherein the earpiece connector component comprises:
at least one power cable electronically coupled to the device power source component;
at least one data cable electronically coupled to the device data communication component; and
an earpiece receptacle comprising at least one power charging pin and at least one data transfer pin, wherein the at least one power charging pin is electronically coupled to the at least one power cable, wherein the at least one data transfer pin is electronically coupled to the at least one data cable.

4. The respiratory protective device of claim 3, wherein the earpiece device comprises at least one power connector contact and at least one data connector contact, wherein, when the at least one power charging pin is electronically coupled to the at least one power connector contact, the earpiece connector component is configured to generate the earpiece connection signal.

5. The respiratory protective device of claim 1, wherein, in response to receiving the earpiece connection signal from the earpiece connector component, the main controller component is configured to:
determine whether a noise reduction indication is received by the main controller component.

6. The respiratory protective device of claim 5, wherein the main controller component is configured to:
in response to determining that the noise reduction indication is received by the main controller component, transmit the reference sound sensor activation signal to the earpiece sound sensor component of the earpiece device.

7. The respiratory protective device of claim 5, wherein the main controller component is configured to:
in response to determining that the noise reduction indication is not received by the main controller component, transmit the sound sensor deactivation signal to the earpiece sound sensor component of the earpiece device.

8. The respiratory protective device of claim 1, wherein the earpiece device comprises an earpiece power source component, wherein the respiratory protective device comprises a device power source component, wherein the main controller component is configured to:
in response to receiving the earpiece connection signal from the earpiece connector component, transmit a power charging signal to the device power source component to cause the device power source component to charge the earpiece power source component of the earpiece device.

9. The respiratory protective device of claim 1, wherein the earpiece device comprises an earpiece data communication component, wherein the respiratory protective device comprises a device data communication component, wherein the main controller component is configured to:
in response to receiving the earpiece connection signal from the earpiece connector component:
transmit a data communication activation signal to the device data communication component; and
transmit a data communication deactivation signal to the earpiece data communication component.

10. The respiratory protective device of claim 1, wherein the earpiece device comprises an earpiece data communication component, wherein the respiratory protective device comprises a device data communication component, wherein the main controller component is configured to:
in response to receiving the earpiece connection signal from the earpiece connector component:
transmit a data communication deactivation signal to the device data communication component; and
transmit a data communication activation signal to the earpiece data communication component.

11. A computer-implemented method comprising:
receiving, by a main controller component of a respiratory protective device, an earpiece connection signal associated with an earpiece device from an earpiece connector component; and
in response to receiving the earpiece connection signal:
transmitting, by the main controller component, a primary sound sensor activation signal to a device sound sensor component disposed on the respiratory protective device; and
transmitting, by the main controller component, at least one of a reference sound sensor activation signal or a sound sensor deactivation signal to an earpiece sound sensor component of the earpiece device.

12. The computer-implemented method of claim 11, wherein the earpiece connector component comprises a connector plug that is detachably connected to a connector receptacle disposed on an outer surface of the respiratory protective device.

13. The computer-implemented method of claim 12, wherein the respiratory protective device comprises a device power source component and a device data communication component, wherein the earpiece connector component comprises:
at least one power cable electronically coupled to the device power source component;
at least one data cable electronically coupled to the device data communication component; and
an earpiece receptacle comprising at least one power charging pin and at least one data transfer pin, wherein the at least one power charging pin is electronically coupled to the at least one power cable, wherein the at least one data transfer pin is electronically coupled to the at least one data cable.

14. The computer-implemented method of claim 13, wherein the earpiece device comprises at least one power connector contact and at least one data connector contact.

15. The computer-implemented method of claim 11, further comprising:
in response to receiving the earpiece connection signal from the earpiece connector component, determining, by the main controller component, whether a noise reduction indication is received.

16. The computer-implemented method of claim 15, further comprising:
in response to determining that the noise reduction indication is received, transmitting, by the main controller component, the reference sound sensor activation signal to the earpiece sound sensor component of the earpiece device.

17. The computer-implemented method of claim 15, further comprising:
in response to determining that the noise reduction indication is not received, transmitting, by the main controller component, the sound sensor deactivation signal to the earpiece sound sensor component of the earpiece device.

18. The computer-implemented method of claim 11, wherein the earpiece device comprises an earpiece power source component, wherein the respiratory protective device comprises a device power source component, wherein the computer-implemented method further comprises:
in response to receiving the earpiece connection signal from the earpiece connector component, transmitting, by the main controller component, a power charging signal to the device power source component to cause the device power source component to charge the earpiece power source component of the earpiece device.

19. The computer-implemented method of claim 11, wherein the earpiece device comprises an earpiece data communication component, wherein the respiratory protective device comprises a device data communication component, wherein the computer-implemented method further comprises:
in response to receiving the earpiece connection signal from the earpiece connector component:
transmitting, by the main controller component, a data communication activation signal to the device data communication component; and
transmitting, by the main controller component, a data communication deactivation signal to the earpiece data communication component.

20. The computer-implemented method of claim 11, wherein the earpiece device comprises an earpiece data communication component, wherein the respiratory protective device comprises a device data communication component, wherein the computer-implemented method further comprises:
in response to receiving the earpiece connection signal from the earpiece connector component:
transmitting, by the main controller component, a data communication deactivation signal to the device data communication component; and
transmitting, by the main controller component, a data communication activation signal to the earpiece data communication component.
